(19) United States
(12) Patent Application Publication
(10) Pub. No.: US 2026/0254538 A1
(43) Pub. Date: Aug. 27, 2026

(54) SYSTEMS AND METHODS FOR DISTRIBUTING QUANTUM ENTANGLEMENT

(71) Applicant: PHOTONIC INC., Coquitlam (CA)

(72) Inventors: Evan MACQUARRIE, Burnaby (CA); Stephanie SIMMONS, Burnaby (CA)

(21) Appl. No.: 18/861,669

(22) PCT Filed: Apr. 25, 2023
(86) PCT No.: PCT/CA2023/050558

§ 371 Date: Oct. 30, 2024

Related U.S. Application Data
(60) Provisional application No. 63/364,246, filed on May 5, 2022.

(51) Int. Cl. H04B 10/70

(52) U.S. Cl. CPC H04B 10/70

(57) ABSTRACT

A nested network includes plural nodes that each includes higher and lower level quantum systems. An intra-node optical network is configurable to interconnect the quantum systems of each of the nodes. An inter-node optical network is configurable to interconnect the higher level quantum systems of the plural nodes. The higher level quantum systems are selectively connectible to the intra-node optical network or the inter-node optical network. Each quantum system may include one or more broker qubits and one or more client qubits. Entanglement of quantum systems in different nodes may be made by making parallel attempts to entangle quantum states of pairs of the higher level quantum systems and, upon successful entanglement of one pair transferring the entanglement to lower level quantum system of each node.

### CROSS-REFERENCE TO RELATED APPLICATIONS

This application claims priority from U.S. application No. 63/364,246 filed 5 May 2022 and entitled SYSTEMS AND METHODS FOR DISTRIBUTING QUANTUM ENTANGLEMENT which is hereby incorporated herein by reference for all purposes. For purposes of the United States of America, this application claims the benefit under 35 U.S.C. § 119 of U.S. application No. 63/364,246 filed 5 May 2022 and entitled SYSTEMS AND METHODS FOR DISTRIBUTING QUANTUM ENTANGLEMENT which is hereby incorporated herein by reference for all purposes.

### FIELD

This technology relates to quantum information and in particular to systems and methods for entangling quantum states of quantum systems.

### BACKGROUND

In distributed quantum computing and other applications of quantum mechanics, it can be desirable to provide quantum systems that have quantum states that are entangled with one another (e.g. pairs of quantum systems that have respective quantum states that form Bell pairs). A pair of quantum systems may be entangled (“bipartite entanglement”) or three or more quantum systems may be entangled (“multipartite entanglement”).

A multipartite entangled state may be created by entangling quantum states of a pair of quantum systems and then extending the entanglement to other quantum systems. For example, quantum states of first, second and third quantum systems may be entangled by first entangling the quantum states of one pair of the quantum systems (e.g. the first and second quantum systems) and then entangling the other (e.g. third) one of the quantum systems with one of the pair of quantum systems (e.g. the first or the second quantum system). This process may be repeated to add additional quantum systems to the multipartite entangled state.

Entangled quantum states have many applications. For example, in quantum computing, Bell pairs may be consumed to execute remote quantum gates between qubits, teleport qubits between different quantum systems. Entangled quantum systems also have applications to quantum cryptography, timekeeping, and other applications.

Realizable quantum systems cannot be completely isolated from their environment. As a result, over time interactions between a quantum system prepared in a particular quantum state and the environment cause random changes to the quantum state of the quantum system. This process is called decoherence. Decoherence will eventually cause entangled quantum systems to lose their entanglement.

There are a variety of known protocols that may be applied for entangling the quantum states of two quantum systems. Some of these protocols are probabilistic in nature (meaning that each attempt to entangle two quantum systems using such protocols has a certain probability of failure). Example protocols for creating entanglement between quantum systems are described in:
S. D. Barrett, et al, PRA 71, 060310R (2005).

Many protocols for entangling two spaced-apart quantum systems are optically mediated. In such protocols, single photons that have quantum states related to quantum states of the two quantum systems (e.g. photons emitted by quantum transitions in one or both of the quantum systems) may be transported via optical paths to locations where interactions with or among the one or more photons may take place. Particularly if the optical paths are lossy any individual attempt to entangle the quantum systems may fail. The average number of attempts required to entangle the quantum systems will increase with the lossiness of the optical paths.

Some entanglement protocols are fundamentally probabilistic. Where such protocols are used, any individual entanglement attempt may fail with a probability that depends on details of the protocol.

Entanglement protocols generally involve several steps. When an entanglement attempt fails, the quantum states of the associated quantum systems may be unknown and it is necessary to reinitialize the quantum systems involved and start the process for creating the desired entangled state again.

The above problems are particularly acute where the goal is to create a multipartite entangled state by a sequence of entanglements since, if any entanglement attempt in the sequence fails then the entire sequence must be started again. The likelihood of successfully creating the multipartite entangled state decreases with the number of entangling operations required to create the desired multipartite entangled state.

The above factors make creating and distributing quantum entanglement challenging since a failed entanglement attempt destroys any entanglement that has been established up to the point of failure.

A strategy for building entangled states using probabilistic entanglement protocols is “brokered entanglement”. Brokered entanglement involves two sets of quantum systems, “broker” quantum systems and “client” quantum systems. In brokered entanglement, quantum states of two or more broker quantum systems may be entangled and the entanglement may subsequently be transferred to corresponding client quantum systems. The brokers may be entangled by a probabilistic entangling protocol. Transfer of the entangled state to clients may be deterministic. A failed attempt to entangle two brokers may be followed by a reset of the brokers which may be done without destroying the states of the corresponding clients.

Brokered entanglement does not eliminate damage to coherent states stored in client qubits from failed entanglement attempts because resetting the brokers can decohere the client qubits. After some number of failed entanglement attempts, the client qubits will have decohered due to interactions with the corresponding broker qubits such that any quantum state stored in the client will be lost.

In executing a probabilistic entanglement process it is typically necessary to know whether or not each entanglement attempt has succeeded. Heralded entanglement protocols may be used. In a heralded entanglement protocol, successful entanglement may be indicated (‘heralded’) by detection of one or more photons. Loss of heralding photons in a detection circuit can mean that a successful entanglement attempt must be treated as a failure. Unfortunately, photon loss in a photonic circuit becomes more probable as the complexity and, most notably, connectivity of the circuit increases. Consequently, how to manage loss of heralding photons can be a very significant problem that interferes with executing quantum circuits that require multiple remote entangling steps.

There is a need for systems and methods that facilitate constructing entangled quantum states for quantum computing and other applications. There is a particular need for such systems and methods that can reliably create and distribute entanglement using lossy optical paths and/or probabilistic entanglement protocols.

### SUMMARY

The present invention includes a number of aspects. These include:
methods for creating and distributing entangled quantum states;
systems for creating and distributing entangled quantum states;
multi-layer quantum networks;
methods for transferring quantum states and/or quantum gates among nodes or cells of a multi-layer quantum network.

One aspect of the invention provides a method for establishing and distributing quantum entanglement. The method comprising: providing first and second nodes each node comprising one or more alpha quantum systems and a plurality of higher level quantum systems. The alpha and higher level quantum systems of each node interconnected by an intra-node optical network and the higher level quantum systems of the first node connectable to at least corresponding higher level quantum systems of the second node by an inter-node optical network. The method attempts to establish quantum entanglement of quantum states of each of a first plurality of pairs of the higher level quantum systems by way of the inter-node optical network. Each of the pairs comprises one of the plurality of higher level quantum systems of the first node and a respective corresponding one of the plurality of higher level quantum systems of the second node. The method comprises detecting success in entangling the quantum states of an entangled pair of the pairs of higher level quantum systems and at each of the first node and the second node, transferring the entanglement of a respective higher level quantum system of the entangled pair of higher level quantum systems to a quantum state of a selected one of the alpha quantum systems of the respective node using the respective intra-node optical network.

In some embodiments, attempting to establish quantum entanglement of quantum states of different ones of the plurality of pairs of the higher level quantum systems is performed concurrently.

In some embodiments, the alpha and higher level quantum systems each comprises a broker element having a broker state and a client element having a client state and the method comprises: entangling the broker states of the one of the pairs of higher level quantum systems; transferring the entanglement to the client states of the higher level quantum systems of the one of the pairs of higher level quantum systems; and transferring the entanglement to the client state of the selected one of the alpha quantum systems of the first node.

In some embodiments, transferring the entanglement to the client states of the higher level quantum systems of the one of the pairs of higher level quantum systems comprises executing a quantum SWAP gate on the higher level quantum systems of the one of the pairs of higher level quantum systems.

In some embodiments, executing the quantum SWAP gate for each of the higher level quantum systems of the one of the pairs of higher level quantum systems comprises promoting a transition from the state |gt↑ [symbol] to the state |g↓ [symbol] and vice versa by applying an RF pulse to the respective one of the higher level quantum systems of the one of the pairs of higher level quantum systems.

In some embodiments, transferring the entanglement to the client state of the selected one of the alpha quantum systems of the first node comprises: at the first node, entangling the broker state of the one of the pair of higher level quantum systems of the first node with the broker state of the selected one of the alpha quantum systems of the first node; at the first node transferring the entanglement of the client state of the higher level quantum system of the one of the pairs of higher level quantum systems of the first node to the client state of the selected one of the alpha quantum systems of the first node.

In some embodiments, the method comprises, at the second node, entangling the broker state of the one of the pair of higher level quantum systems of the second node with the broker state of the selected one of the alpha quantum systems of the second node; and at the second node transferring the entanglement of the client state of the higher level quantum system of the one of the pairs of higher level quantum systems of the second node to the client state of the selected one of the alpha quantum systems of the second node.

In some embodiments, transferring the entanglement of the client state of the beta quantum system of the one of the pairs of beta quantum systems of the first and/or second node to the client state of the respective selected one of the alpha quantum systems of the first and/or second node comprises performing a quantum teleportation procedure.

In some embodiments, the broker state and the client state respectively comprise first and second spin states.

In some embodiments, the first spin state comprises an electron spin state.

In some embodiments, the second spin state comprises a nuclear spin state.

In some embodiments, for at least one of the first and second nodes, transferring the entanglement of a respective higher level quantum system of the entangled pair of higher level quantum systems to a quantum state of a selected one of the alpha quantum systems of the respective node using the respective intra-node optical network comprises transferring the entanglement to the selected one of the alpha quantum systems comprises transferring the entanglement in sequence from the respective higher level quantum system to one or more intermediate level quantum systems and from one of the one or more intermediate level quantum systems to the selected alpha quantum system.

In some embodiments, the one or more intermediate level quantum systems comprises a beta quantum system and the intra-node optical network comprises an optical link that directly connects the alpha quantum system to the beta quantum system.

In some embodiments, the quantum systems are embedded in a crystalline substrate.

In some embodiments, the quantum systems comprise luminescent centres.

In some embodiments, the higher level quantum systems each comprise a T centre.

In some embodiments, each of the first and second nodes comprises at least five of the higher level quantum systems and the method comprises in parallel, attempting to establish quantum entanglement of quantum states of each of at least five of the higher level quantum systems of the first node with a quantum state of a respective corresponding one of the plurality of higher level quantum systems of the second node.

In some embodiments, each of the first and second nodes comprises at least ten of the higher level quantum systems and the method comprises in parallel, attempting to establish quantum entanglement of quantum states of each of at least ten of the beta quantum systems of the first node with a quantum state of a respective corresponding one of the plurality of higher level quantum systems of the second node.

In some embodiments, the method comprises teleporting a quantum gate or a quantum state from the first node to the second node using the entanglement of the quantum states of the respective selected ones of the alpha quantum systems.

In some embodiments, the method comprises configuring the intra-node network of the first node to provide an optical connection between the higher level quantum system and either the selected one of the alpha quantum systems or a beta quantum system associated with the selected one of the alpha quantum systems.

In some embodiments, the first node comprises N higher level quantum systems and each of the N higher level quantum systems is connected to a corresponding port of a first optical switch that is operative to selectively couple the higher level quantum system either to the intra node optical network or to the inter node optical network and configuring the intra-node network of the first node comprises operating the first optical switch to connect the higher level quantum system of the entangled one of the pairs of higher level quantum systems to the intra node optical network of the first node.

In some embodiments, the first node comprises M alpha quantum systems and each of the M alpha quantum systems is coupled to a corresponding port of a second optical switch and configuring the intra-node network of the first node comprises operating the second optical switch to connect the selected one of the alpha quantum systems and the higher level quantum system that belongs to the entangled one of the pairs of higher level quantum systems.

In some embodiments, the method comprises extending the entanglement of the entangled one of the pairs of higher level quantum systems to provide a multipartite entangled state of three or more of the higher level quantum systems.

In some embodiments, the three or more of the higher level quantum systems in the multipartite entangled state include higher level quantum systems in at least the first node, the second node and a third node.

In some embodiments, the intra-node optical network is characterized by a lossiness of less than 3 dB.

In some embodiments, the inter-node optical network is characterized by a lossiness of more than 3 dB.

In some embodiments, the method comprises maintaining a resource of at least one entangled pair of the higher level quantum systems by continuing to attempt to establish quantum entanglement of quantum states of pairs of the higher level quantum systems by way of the inter-node optical network at a rate sufficient to replace entangled pairs of the higher level quantum systems that are consumed or cease to be entangled by quantum decoherence.

In some embodiments, the method comprises providing a third node comprising one or more alpha quantum systems and a plurality of higher level quantum systems and attempting to establish quantum entanglement of quantum states of each of a second plurality of pairs of the higher level quantum systems by way of the inter-node optical network, wherein each of the second plurality of pairs comprises one of the plurality of higher level quantum systems of the first node and a respective corresponding one of the plurality of higher level quantum systems of the third node.

Another aspect of the invention provides a quantum network comprising a plurality of nodes or cells. Each node or cell comprises: at least one alpha quantum system, a plurality of higher level quantum systems and an intra-node optical network optically coupled to the at least one alpha quantum system and the plurality of higher level quantum systems. An inter-node optical network is configurable to provide a plurality of optical paths, each of the optical paths optically connecting a corresponding pair of the higher-level quantum systems. Each of the pairs includes one of the higher level quantum systems of a first one of the nodes and a corresponding higher level quantum system of a second one of the nodes. A controller is configured to: concurrently execute, via the inter-node optical network attempts to entangle the higher level quantum systems of each of the pairs of beta quantum systems; upon detecting entanglement of the higher level quantum systems of an entangled one of the pairs of higher level quantum systems, transfer, via the intra-node optical network, an entangled state of the entangled one of the pairs of higher level quantum systems to a selected alpha quantum system of the one or more alpha quantum systems of the first one of the nodes and/or a selected alpha quantum system of the one or more alpha quantum systems of the second one of the nodes.

In some embodiments, the alpha and higher level quantum systems each comprises a broker element having a broker state and at least one client element having a client state.

In some embodiments, the controller is further configured to: execute a protocol for entangling the broker states of the pairs of higher level quantum systems; upon entanglement of the broker states of the entangled one of the pairs of higher level quantum systems, execute a protocol for transferring the entanglement to the client states of the higher level quantum systems of the entangled one of the pairs of higher level quantum systems; execute a protocol for entangling the broker state of the higher level quantum system of the entangled one of the pairs of higher level quantum systems of the first node with the broker state of the selected one of the alpha quantum systems of the first node; execute a protocol for transferring the entanglement of the client state of the higher level quantum system of the entangled one of the pairs of higher level quantum systems of the first node to the client state of the selected one of the alpha quantum systems of the first node.

In some embodiments, the broker state and the client state respectively comprise first and second spin states.

In some embodiments, the first spin state comprises an electron spin state.

In some embodiments, the second spin state comprises a nuclear spin state.

In some embodiments, the broker element and the client element have a fixed spatial relationship in each of the alpha quantum systems.

In some embodiments, a strength of hyperfine coupling between the broker element and the client element is the same for each of the alpha quantum systems.

In some embodiments, each of the alpha quantum systems and/or each of the higher level quantum systems is embedded in a crystalline substrate.

In some embodiments, the quantum systems comprise luminescent centres.

In some embodiments, the higher level quantum systems each comprise a T centre.

In some embodiments, the inter-node optical network is lossier than the intra-node optical networks of the first and second nodes.

In some embodiments, the intra-node optical network is characterized by a lossiness of less than 3 dB.

In some embodiments, the inter-node optical network is characterized by a lossiness of more than 3 dB.

In some embodiments, each of the nodes includes at least five of the higher level quantum systems.

In some embodiments, for each of the plurality of nodes, the intra-node network comprises an optical mixer having first and second input ports and first output ports, and a single photon detector at each of the output ports and the controller is configured to configure the intra-node network to optically couple the selected alpha quantum system to the first input port of the optical mixer and to optically connect the higher level quantum system of the entangled pair to the second input port of the optical mixer.

In some embodiments, each of the plurality of nodes comprises a first optical switch having a plurality of input ports, each of the plurality of input ports optically connected to a respective one of the one or more alpha quantum systems of the node and an output port optically connected to the first input port of the optical mixer.

In some embodiments, for each of the plurality of nodes, the intra-node network comprises an optical mixer having first and second input ports and first and second output ports, and a single photon detector at each of the output ports and the controller is configured to configure the intra-node network to optically couple a quantum system that is intermediate between the selected alpha quantum system and the higher level quantum system of the entangled pair to the first input port of the optical mixer and to optically connect the higher level quantum system of the entangled pair to the second input port of the optical mixer.

In some embodiments, each of the plurality of nodes comprises a first optical switch having a plurality of input ports, each of the plurality of input ports optically connected to a respective one of a plurality of quantum systems of the node and an output port optically connected to the first input port of the optical mixer.

In some embodiments, each of the plurality of nodes comprises a second optical switch having a plurality of input ports, each of the plurality of input ports optically connected to a respective one of the plurality of higher level quantum systems of the node and an output port optically connected to the second input port of the optical mixer.

Another aspect of the invention provides a method for distributing quantum entanglement, the method comprising: providing a plurality of cells, each of the cells comprising a plurality of quantum systems, the plurality of quantum systems including: a plurality of higher level quantum systems that are each selectively connectable to either an inter-cell optical network or an intra-cell optical network; and one or more alpha quantum systems that are connectable to the intra-cell optical network; configuring the inter cell optical network to pairwise connect a plurality of pairs of the higher level quantum systems where each of the pairs includes two of the higher level quantum systems and the two higher level quantum systems are in different ones of the cells; attempting to establish quantum entanglement of quantum states of each of the plurality of pairs of the higher level quantum systems by way of the inter-cell optical network.

In some embodiments, the plurality of cells includes three of more of the cells and, for at least one of the cells, the plurality of higher level quantum systems includes one or more higher level quantum systems paired with a corresponding higher level quantum system of a first other one of the cells and one or more higher level quantum systems paired with a corresponding higher level quantum system of a second other one of the cells.

In some embodiments, attempting to establish quantum entanglement of quantum states of each of the plurality of pairs of the higher level quantum systems is performed concurrently for at least five of the pairs.

In some embodiments, the method comprises maintaining at least a set number of the pairs of higher level quantum systems in an entangled state and automatically replenishing the entangled pairs in response to entanglement of the pairs being consumed.

In some embodiments, the method comprises automatically replenishing the entangled pairs in response to a predetermined time having passed since entanglement of one of the entangled pairs.

In some embodiments, the method comprises detecting success in entangling the quantum states of an entangled pair of the pairs of higher level quantum systems; at each of a first cell and a second cell of the plurality of cells, transferring the entanglement of a respective higher level quantum system of an entangled pair of the higher level quantum systems to a quantum state of a selected one of the alpha quantum systems of the respective cell using the respective intra-cell optical network.

In some embodiments, the alpha quantum systems and the higher level quantum systems each comprises a broker element having a broker state and a client element having a client state and the method comprises: entangling the broker states of the higher level quantum systems of one of the pairs of higher level quantum systems; transferring the entanglement of the broker states to the client states of the higher level quantum systems of the one of the pairs of higher level quantum systems.

Another aspect of the invention provides a system for distributing quantum entanglement. The system comprises a plurality of cells. Each of the cells comprises a plurality of quantum systems that includes: a plurality of higher level quantum systems that are each selectively connectable to either an inter-cell optical network or an intra-cell optical network; and one or more lower level quantum systems that are connectable to the intra-cell optical network. The system comprises a controller operable to: configure the inter-cell optical network to pairwise connect a plurality of pairs of the higher level quantum systems where each of the pairs includes two of the higher level quantum systems and the two higher level quantum systems of each of the plurality of pairs are in different ones of the cells; perform a non-deterministic quantum entanglement protocol on the higher level quantum systems of each of the plurality of pairs of the higher level quantum systems using the inter-cell optical network.

In some embodiments, the inter-cell optical network comprises a plurality of optical mixers, each of the optical mixers having first and second input ports and configuring the inter-cell optical network comprises, for each of the pairs, coupling the higher level quantum systems of the pair to the first and second input ports of a corresponding one of the plurality of optical mixers.

In some embodiments, each of the cells comprises first optical switching operative to selectively couple each of the higher level quantum systems of the cell to the inter-cell optical network or the intra-cell optical network.

In some embodiments, each of the cells comprises second optical switching operative to selectively connect one of the lower level quantum systems of the cell to any one of the plurality of higher level quantum systems of the cell.

In some embodiments, the one of higher level quantum systems is a beta quantum system and the cell comprises an alpha quantum system connectible to the beta quantum system by the intra-cell optical network.

In some embodiments, the alpha quantum system and the beta quantum system each comprises a broker element having a broker state and a client element having a client state.

In some embodiments, the broker state and the client state respectively comprise first and second spin states.

In some embodiments, the first spin state comprises an electron spin state.

In some embodiments, the second spin state comprises a nuclear spin state.

In some embodiments, the quantum systems are embedded in a crystalline substrate.

In some embodiments, the quantum systems comprise luminescent centres.

In some embodiments, the higher level quantum systems each comprise a T centre.

Another aspect of the invention provides a layered quantum network comprising: a plurality of quantum systems. Each of the quantum systems comprises a broker element and a client element. The plurality of quantum systems is associated with optical networks to provide a layered topology in which: a first plurality of the quantum systems designated as alpha quantum systems are each associated with one of a plurality of corresponding nodes, a second plurality of the quantum systems designated as beta quantum systems are each associated with a corresponding one of the nodes. Each of the nodes has a respective intra-node optical network. The beta quantum systems are selectively connectable to the corresponding one of the plurality of intra-node optical networks or one of at least one inter-node optical network. A controller is configured to: entangle quantum states of a pair of the beta quantum systems, the pair including first and second ones of the beta quantum systems wherein the first and second beta quantum systems of the pair are respectively associated with first and second different ones of the nodes, by executing a probabilistic entanglement protocol, and apply resulting entangled quantum states of the pair of the beta quantum systems to teleport a quantum state of an alpha quantum system of the first node or a quantum gate involving an alpha quantum system of the first node to the second node.

In some embodiments, the intra-node optical networks are characterized by probabilities of loss of single photons that are lower than probabilities of loss of single photons of the at least one inter-node optical network.

In some embodiments, the intra-node optical network comprises a third plurality of the quantum systems designated as gamma quantum systems which are each associated with a corresponding one of the nodes and the intra-node network is configurable to provide optical links that connect pairs of the gamma quantum systems wherein each of the pairs of gamma quantum systems comprises a first gamma quantum system and a second gamma quantum system wherein the first and second gamma quantum systems of each of the pairs are respectively associated with different ones of the nodes and the inter-node optical network is further configurable to provide optical links connecting the first and second gamma quantum systems of each pair to at least one of the beta quantum systems of the respective node.

In some embodiments, the intra-node optical networks are each configurable to establish optical connections between alpha quantum systems of the corresponding node and beta quantum systems of the corresponding node, each of the optical connections comprising an interaction unit having first and second inputs respectively arranged to receive photon states originating from the connected alpha and beta quantum systems and first and second outputs respectively arranged to deliver photons to first and second single photon detectors, the interaction units configured to allow interference between the photon states originating from the connected alpha and beta quantum systems.

Another aspect of the invention provides a layered quantum network comprising quantum systems arranged in at least three layers. The layered quantum network comprises: a top layer comprising a plurality of the quantum systems designated as top layer quantum systems; a bottom layer comprising a plurality of the quantum systems designated as bottom layer quantum systems distributed among a plurality of cells; one or more intermediate layers, each of the intermediate layers comprising a respective plurality of the quantum systems designated as intermediate layer quantum systems; and an optical network configurable to provide a chain of optical links that extend from a first one of the bottom layer quantum systems in a first one of the cells to a second one of the bottom layer quantum systems in a second one of the cells by way of the intermediate layer quantum systems and the top layer quantum systems. The optical network includes a plurality of intra-cell optical networks each associated with a respective one of the cells and an inter-cell optical network configurable to provide optical links that connect the quantum systems associated with a cell with other ones of the quantum systems outside of the cell. The chain of optical links including: an optical link connecting the first bottom layer quantum system to a first one of the intermediate layer quantum systems; an optical link connecting the second bottom layer quantum system to a second one of the intermediate layer quantum systems; a top layer optical link connecting a pair made up of first and second ones of the top layer quantum systems; one or more optical links directly or indirectly connecting the first intermediate layer quantum system to the first top layer quantum system; and one or more optical links directly or indirectly connecting the second intermediate layer quantum system to the second top layer quantum system. A controller is configured to distribute quantum entanglement to the first and second intermediate quantum systems by executing a heralded entanglement protocol to entangle quantum states of the first and second top layer quantum systems and extending the entanglement to the first and second intermediate layer quantum systems.

In some embodiments, the controller is further configured to: entangle quantum states of each of a plurality of pairs of the top layer quantum systems; extend the entanglement of each of the plurality of pairs of top level quantum systems to a respective pair of the intermediate layer quantum systems; and purify the entanglement of the entangled pairs of intermediate layer quantum systems.

In some embodiments, the controller is configured to cause teleportation of the quantum state of the first bottom layer quantum system to the second bottom layer quantum system using the entanglement of the quantum states of the first and second intermediate layer quantum systems.

In some embodiments, the controller is configured to cause teleportation of a quantum gate controlled by the first bottom layer quantum system to apply the quantum gate to the second bottom layer quantum system using the entanglement of the quantum states of the first and second intermediate layer quantum systems.

Further aspects and example embodiments are illustrated in the accompanying drawings and/or described in the following description.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIG. 1 is a schematic depiction of a system according to a simple example embodiment of the present technology.

FIG. 1A is a schematic depiction of an example node that may be used in a system of the present technology.

FIG. 2 is a flow chart for a method according to an example embodiment.

FIG. 3 is a block diagram for a hardware implementation of an example node.

FIG. 4 is a block diagram for a hardware implementation of an example inter-node network.

FIG. 5 is a schematic cross section of a substrate supporting a quantum system and apparatus for working with a quantum state of the quantum system.

FIG. 6 is an example energy level diagram for quantum systems that may be incorporated in systems according to the present technology.

FIG. 7 is a flowchart illustrating a method for creating and distributing entanglement applicable to the case where individual quantum systems include broker elements and client elements.

FIG. 8 is a schematic illustration showing an example sequence of interactions that may be applied to create entanglement of alpha client qubits in a system according to the present technology.

FIG. 8A is an example energy level diagram with annotations showing one way for initializing a quantum system in a desired state.

FIGS. 8B, 9 and 9A are quantum circuit diagrams that respectively illustrate a sequence for entangling alpha client qubits of two nodes; a sequence for creating multipartite entanglement of several qubits; and a sequence for teleporting a quantum CNOT gate.

FIG. 10 is a schematic illustration showing an example network having three layers of quantum systems.

FIGS. 10A, 10B and 10C are diagrams showing example interconnection topologies that may be present in systems as described herein.

FIG. 11 is a graph illustrating the effect of the number of parallel entanglement attempts on a time required to establish an entangled pair of qubits.

FIG. 12 is a graph that illustrates the effect of photon loss on fidelity of an entangled state.

### DEFINITIONS

“Connected” in the context of quantum systems means “connected” by an optical path, optical link, optical waveguide or optical network extending between the quantum systems. “Connected” includes the case where the optical path, optical link, optical waveguide or optical network is operable to carry photons or photon states emitted by each of the quantum systems to a location (e.g. an optical mixer, optical beamsplitter, optically coupled waveguides etc.) where the photons or photon states can interact (e.g. interfere) with one another. For example, two quantum systems are “connected” when an optical network is configured to deliver photons originating from each of the optical systems to a an interaction unit having first and second inputs respectively arranged to receive photon states originating from the connected quantum systems and first and second outputs respectively arranged to deliver photons to first and second single photon detectors where the interaction units are configured to allow interference between the photon states originating from the connected quantum systems.

“Entanglement” describes the situation in which quantum states of individual quantum systems in a group of two or more quantum systems cannot be described independently of the quantum states of the other ones of the quantum systems in the group. An equivalent definition of an entangled state is a state of plural quantum systems that cannot be factored into states of the individual quantum systems that make it up. For example, two entangled particles may each have a quantum state which is a superposition of spin up and spin down while the combined spin of the two particles is constrained to be zero. Entanglement can exist even between quantum systems that are separated by very large distances.

“Highly entangled state” means a state that is maximally entangled or close to being maximally entangled. A Bell pair is an example of a highly entangled state.

“Qubit” means a quantum system that has first and second quantum states that can be used to represent quantum information and which can exist in a quantum superposition. Examples of quantum systems that may be used as qubits include particles that have spin (e.g. electrons, atomic nuclei, holes) where different spin states may represent information; particles that have excitonic states where the absence or presence of an exciton may represent information, particles e.g. electrons that have different orbital states where the orbital state occupied by the particle represents information and so on.

“Qutrit” means a quantum system that has three or more quantum states that can be used to represent quantum information and can exist in quantum superpositions. A particle having a spin greater than ½ may, for example be applied as a qutrit.

“Broker quantum system” means a quantum system that is applied as a conduit to transfer a quantum state deterministically to another quantum system (client quantum system).

“Client quantum system” means a quantum system that receives transfer of a quantum state from a broker quantum system.

“Quantum system” means a system that has practical application for storing and/or manipulating quantum information. A quantum system supports plural quantum states and superpositions of at least two supported quantum states. Examples of quantum systems are spins (e.g. electron spins, nuclear spins), qubits, qutrits, quantum dots, damage centers such as T, I and M centers, NV centers, impurity atoms in silicon or other substrates and collections of two or more of these. In some embodiments, quantum systems are used as qubits. For example, a quantum system may consist of or include a spin that has two spin states and the spin may be used as a qubit to store and manipulate information that is represented by individual ones or superpositions of the two spin states.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

One application of the present technology is to establish entanglement between quantum systems that are connected by an optical path (e.g. an optical waveguide, an optical fiber, open space etc.). In some embodiments the optical path is non-deterministic, meaning that identical photons or photon states emitted into the optical path can be affected in different ways by propagation along the optical path. For example, some photons or photon states may be lost by the optical path or some photons or photon states may experience different changes in phase/polarization or other properties as they propagate along the optical path.

In some embodiments the optical path is lossy (i.e the probability that a photon delivered into one end of the optical path will reach the other end of the optical path is less than about 50% (corresponding to a 3 dB loss). In some embodiments the optical path has a loss in the range of about 3 dB to about 40 dB (corresponding to a likelihood that a single photon will traverse the optical path without being lost in the range of about 50% to about 0.01%).

A probabilistic entanglement protocol may be applied to establish entanglement of quantum systems connected by the optical path. The likelihood of successful entanglement from one execution of a probabilistic entanglement protocol varies with details of the protocol and the probability that single photons created in executing the protocol will be detected. In some embodiments the likelihood that any single execution of the probabilistic entanglement algorithm will result in entanglement is less than about 13%. Some embodiments execute probabilistic entanglement protocols over lossy optical links where the probability of successful entanglement from one iteration of the entanglement is in the range of about 10-7% to about 20%.

The present technology provides an approach that may be applied to mitigating issues as described in the Background section. This approach involves providing plural quantum systems connected by an optical path and simultaneously executing the entanglement protocol for pairs of the quantum systems where each of the pairs includes a quantum system connected by the optical path.

As soon as the quantum systems of any one of the pairs is successfully entangled the goal of obtaining entanglement of quantum systems at either end of the optical path is achieved. The entangled pair may then be applied as a resource, for example, to teleport a quantum state or a quantum gate from one end of the optical path to the other; apply for quantum cryptography; or use for any other application of entanglement.

In preferred embodiments, execution of the entanglement protocol is automated. A computer system may coordinate the performance of steps of the entanglement protocol for different pairs of the quantum systems and may determine when entanglement of the quantum systems of any of the pairs has been established. In some embodiments entanglement attempts are made essentially continuously so that at any given time one or more of the pairs of qubits is entangled and available as a resource. In some embodiments the entanglement attempts are performed on demand and since any practical number of entanglement attempts may be made simultaneously the time required to establish an entangled pair of quantum systems is reduced significantly compared to the case where entanglement attempts are repeated serially on a single pair of quantum systems until entanglement has been achieved.

Without loss of generality the quantum systems that are located at either end of the optical path may be considered to belong to a “node” or a “cell”. The present technology may be applied to establish entanglement among quantum systems at different nodes and/or to distribute the entanglement to one or more other quantum systems within a node. There is no requirement that nodes be physically separated by any particular distances although they may be separated by any distance including distances ranging from very large to very small distances.

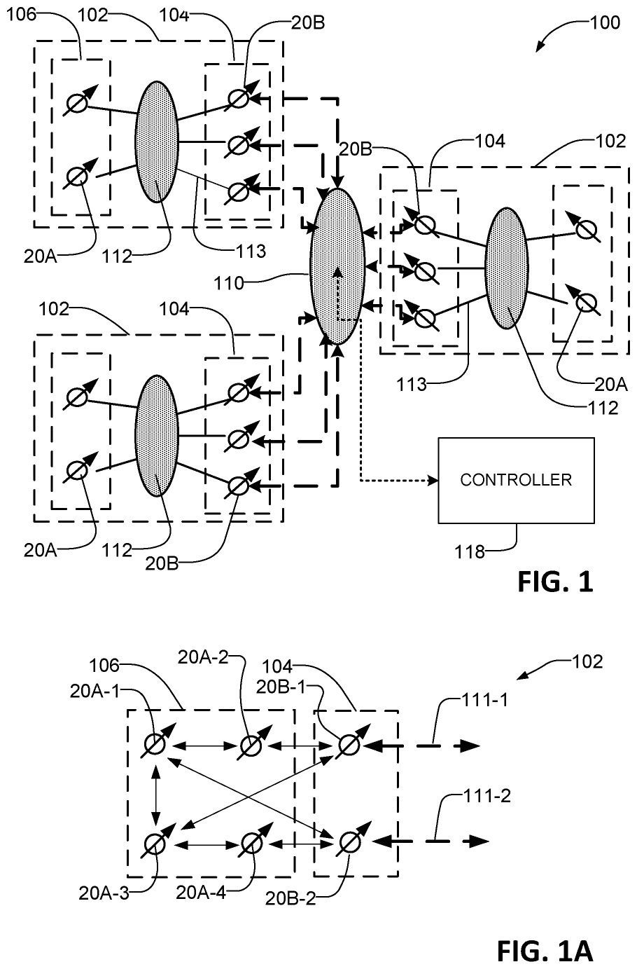

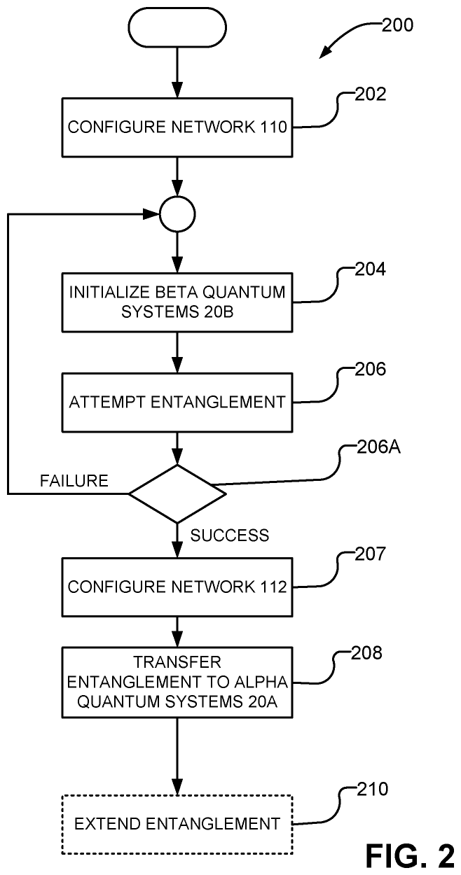

FIG. 1 illustrates an example system 100 according to an example implementation of the present technology. System 100 may be applied to efficiently construct entangled states. System 100 comprises a plurality of nodes 102. FIG. 1 shows a simple example in which system 100 includes quantum systems associated with three nodes 102. However a system 100 may have from two up to any practical number of nodes 102.

Each node 102 comprises a plurality of quantum systems. FIG. 1 includes quantum systems 20A and 20B (collectively or generally quantum systems 20). System 100 may be operated as described herein to create entanglement among two or more of quantum systems 20B in two or more of nodes 102.

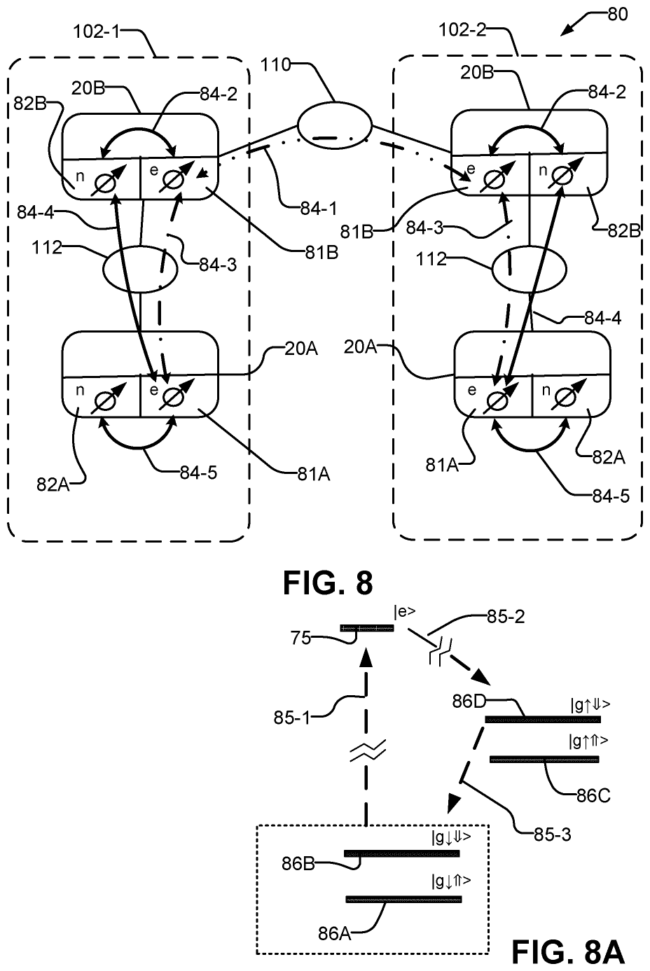

To explain the operation of system 100 it is convenient to consider the case where each quantum system 20 is a qubit. Quantum systems 20 are not limited to being qubits (e.g. they may comprise qutrits or systems that combine two or more qubits and/or qutrits as in other examples described herein). As described below (see e.g. FIG. 7), in some embodiments each quantum system 20 includes an element that can serve as a broker and an element that can serve as a client. By way of example only, the broker element may comprise an electron spin and the client element may comprise a nuclear spin.

Quantum systems 20 may, for example, be realized by particles that possess intrinsic spin. Different spin states may correspond to different computational values. Since quantum systems 20 are quantum systems they are not limited to being in a specific spin state. For example, a particle having spin ½ may be observed to have spin up or spin down with respect to any chosen axis. However, the particle may have a quantum state that is a specific superposition of spin up and spin down.

System 100 includes optical paths that connect different nodes 102. In the illustrated embodiment the optical paths are provided by a reconfigurable inter-node optical communication network 110. Network 110 is highly connected and, in particular, is configurable to simultaneously provide a plurality of optical links between any two nodes 102 in system 100 such that each of the optical links provides an optical path that optically couples one quantum system 20B in a first one of the nodes 102 to one quantum system 20B in another one of the nodes 102.

Entanglement may be created between pairs of quantum systems 20B in different nodes 102, for example as described above. Such entanglement may optionally be extended to multipartite entanglement of a group of three or more quantum systems 20B for applications in which multipartite entanglement is desired.

In the illustrated embodiment, each node 102 includes one or more additional quantum systems 20A. Specifically, each node 102 includes a group 104 made up of a plurality of quantum systems 20B and a group 106 made up of one or more other quantum systems 20A.

Quantum systems 20A may be called “alpha” quantum systems and quantum systems 20B may be called “beta” quantum systems. This nomenclature reflects the idea that quantum systems 20 of system 100 may be considered to be logically arranged in “layers” (e.g. an alpha layer and a beta layer) in which the quantum systems 20 belonging to each layer may serve a different role. For example, beta quantum systems 20B may be applied to establish entanglement between different nodes 102 and alpha quantum systems 20A may be used in operations that consume the entanglement provided by beta quantum systems 20B. This structure of nested layers may be extended to three or more layers (e.g. alpha, beta, gamma layers).

In each node 102, a low loss optical network 112 connects beta quantum systems 20B of the node 102 to alpha quantum systems 20A of the node 102. In some embodiments low loss optical network 112 includes low-loss optical paths 113 that connect each one of beta quantum systems 20B to each one of alpha quantum systems 20A. Low loss optical paths 113 facilitate applying deterministic quantum operations among quantum systems 20A, 20B of any node 102.

It is not required that the quantum systems 20 of a node 102 bear any particular spatial relationship to one another. The quantum systems 20 of a node 102 are interconnected by a low loss optical network 112 and beta quantum systems 20B of the node 102 are connectable to quantum systems outside of the node 102 by way of optical communication network 110. The optical links provided by networks 110 and 112 may have any practical lengths from small to very significant.

Nodes 102 may be spatially separated from one another but this is not mandatory in all implementations. Implementations are possible in which quantum systems of two or more distinct nodes 102 are at intermingled locations (e.g. distributed in the same area of a substrate). Other implementations are possible in which quantum systems 20 off distinct nodes 102 are more widely separated (e.g. located on different substrates, in different refrigerators, in different buildings etc.). Quantum systems 20 belonging to the same node 102 may be spaced closely together and/or widely distributed.

FIG. 1A shows a very simple example of one node 102-1. Node 102-1 includes two or more beta quantum systems and one or more alpha quantum systems. In this example, node 102-1 includes two beta quantum systems 20B (individually identified as 20B-1 and 20B-2) as well as four alpha quantum systems 20A (individually identified as 20A-1 through 20A-4). Each beta quantum system 20B is optically connected or connectable to a corresponding waveguide 111 (portions of waveguides 111-1 and 111-2 are shown) of inter-node network 110. Each alpha quantum system 20A and each beta quantum system 20B are optically connected or connectable to a waveguide 113 of low loss optical network 112.

System 100 includes additional elements as described elsewhere herein including a controller 118 which coordinates operation of system 100. Controller 118 may, for example, be configured to: set and/or manipulate quantum states of quantum systems 20 and/or control optical networks 110 and/or 112 to provide desired optical connectivity between quantum systems 20.

Mechanisms for setting and manipulating quantum states of quantum systems 20 may depend on the natures of quantum systems 20 and may include, for example, mechanisms which generate bias and/or local magnetic fields, sources of radiation that may be delivered to quantum systems 20 individually and/or in groups (e.g. optical radiation, radiofrequency radiation such as, for example, microwave radiation), mechanisms for applying electrical fields to individual quantum systems 20, etc. Controller 118 may, for example, be configured to initialize any of quantum systems 20 in a desired quantum state by applying combinations of optical and/or radiofrequency pulses to the quantum system 20 as is known in the art. Example coordination tasks that controller 118 may be configured to perform include: executing single qubit control operations, processing the results of single qubit measurements, and dynamically reconfiguring optical network 110 and/or optical network 112 as needed to optimize network connections for creation and distribution of entanglement.

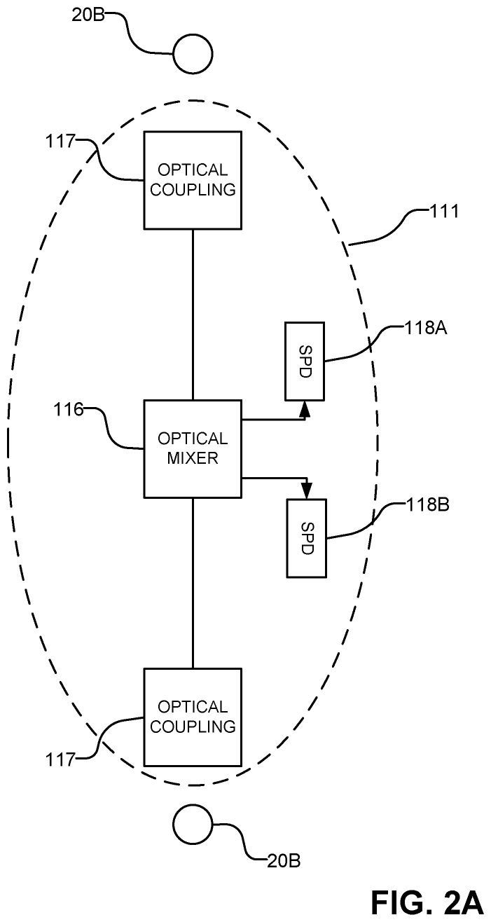

FIG. 2 is a flow chart which outlines a method 200 for creating entanglement between a selected alpha quantum system 20A of a first one of nodes 102 and a selected alpha quantum system 20A of a second one of nodes 102.

In block 202, network 110 is configured to pairwise optically connect each of a plurality of beta quantum systems 20B of node 102A to a corresponding one of a plurality of beta quantum systems 20B of node 102B in a way that facilitates entangling the beta quantum systems 20B of each pair.

In block 204 beta quantum systems 20B of each of two nodes (e.g. nodes 102A and 102B-see FIG. 2A) are initialized to quantum states appropriate for a probabilistic entanglement protocol to be applied in attempts to entangle the quantum states of the pairs of quantum systems 102B.

In block 206, method 200 commences attempts to entangle each pair of beta quantum systems 20B. These attempts may be made in parallel (e.g. at the same or overlapping times). Attempts to entangle different ones of the pairs of beta quantum systems 20B may be asynchronous or synchronous. Each entanglement attempt may comprise applying a sequence of operations of a protocol for entanglement of the corresponding pair of beta quantum systems 20B. The protocol may be a probabilistic protocol. For example, each entanglement attempt may comprise applying steps of an entanglement protocol as described in S. D. Barrett, et al, PRA 71, 060310R (2005).

Block 206 is repeated until it is verified that at least one of the pairs of beta qubits has been successfully entangled as determined at block 206A. In some embodiments, success at block 206A is detected by detecting a heralding pattern of photon detection events at optical detectors corresponding to one of the pairs of beta quantum systems 20B.

FIG. 2A illustrates an example optical path 111 of network 110 that is optically connected between two quantum systems 20B by suitable optical couplers 117. Optical path 111 includes an optical mixer 116 at which single photon states associated with quantum systems 20B may interfere. Single photon detectors 118A and 118B are operative to detect photons in patterns that herald entanglement (or indicate that an entanglement attempt is not successful).

Any of the entanglement attempts initiated in block 206 may fail. Failure may be due to any cause including loss of a photon in network 110, improper initialization of quantum systems 20B etc. Network 110 may suffer from significant optical losses (e.g. due to factors such as the distances between nodes 102, optical losses associated with switches used to configure network 110 to provide the desired connections, less than 100% efficiency of single photon detectors etc.). Failure of an entanglement attempt may be detected, for example, by observing a pattern of photon detections at corresponding optical detectors 118A and 118B that do not correspond to successful entanglement and/or not observing a pattern of photon detections at detectors 116 that does correspond to successful entanglement.

If an entanglement attempt for a pair of beta quantum systems 20B fails then block 206 may reinitialize each of the pair of beta quantum systems 20B and try again to entangle the pair of beta quantum systems. At the end of block 206 at least one pair of beta quantum systems 20B, including one beta quantum system 20B in node 102A and one beta quantum system 20B in node 102B are entangled. For example, block 206 may be complete when successful entanglement of at least one pair of beta quantum systems 20B is heralded.

Because many entanglement attempts may be performed in parallel, the amount of time expected to obtain at least one pair of beta quantum systems 20B that is entangled may be significantly reduced as compared to the case where serial attempts are made to entangle one pair of beta quantum systems 20B.

As discussed elsewhere herein, in some embodiments a beta quantum system 20B may include two or more elements that each have a distinct quantum state (e.g. one or more electron spins and/or one or more nuclear spins). In such cases, the steps of method 200 may be applied to individual ones of these elements. For example, block 206 may be completed when the quantum state of an electron spin (or nuclear spin) element of one beta quantum system 20B is entangled with the quantum state of a corresponding electron spin (or nuclear spin) in a paired one of beta quantum systems 20B.

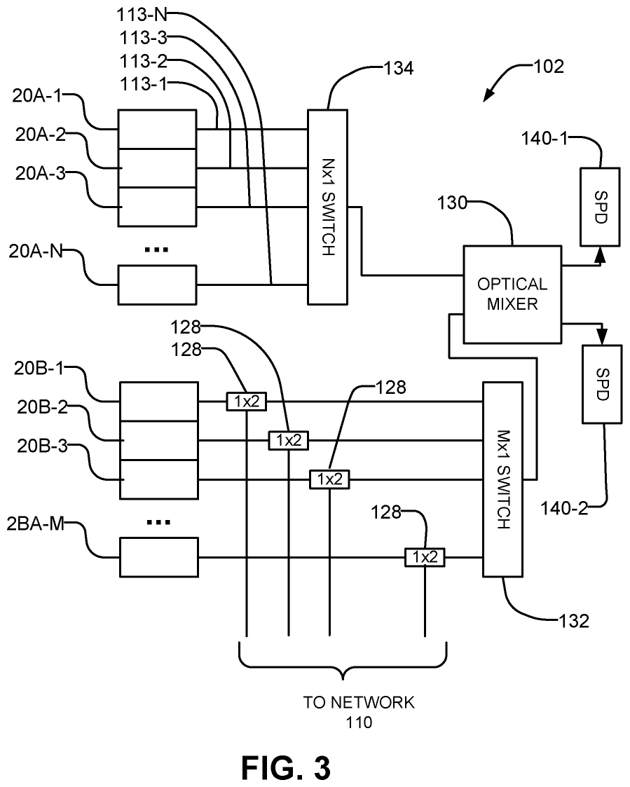

FIG. 3 is a block diagram showing an example implementation of a single node 102 having N alpha quantum systems 20A and M beta quantum systems 20B. In this example embodiment, switches 128 may be operated to connect beta quantum systems 20B either to inter-node network 110 or intra-node network 112. Switches 128 may be operated to connect some or all beta quantum systems 20B to inter-node network 110 for the purpose of generating entanglement with beta quantum systems of other nodes 102. Switches 128 may be set to connect one or more beta quantum systems 20B to intra-node network 112 for the purpose of transferring entanglement to a selected one of alpha quantum systems 20A.

Intra-node network 112 allows any pair made up of one of beta quantum systems 20B and one of alpha quantum systems 20A to be connected to an optical mixer 130 (which may, for example comprise a beamsplitter). Optical mixer 130 has two outputs which are each connected to a corresponding single photon detector (140-1 and 140-2).

In the embodiment of FIG. 3, intra-node network 112 comprises an M×1 optical switch 132 which allows connection of any one of beta quantum systems 20B1-1 to 20B-M to be connected to one input of optical mixer 130 and an N×1 optical switch 134 which allows connection of any one of alpha quantum systems 20A-1 to 20A-N to be connected to a second input of optical mixer 130. Optical switches 128, 130 and 132 may be controlled by controller 118.

In some embodiments, some or all of switches 128 are initially set to connect corresponding beta quantum systems 20B to corresponding optical links of inter-node network 110. Attempts are made to entangle the beta quantum systems 20B with corresponding external quantum systems outside of the node 102. On detection of entanglement of one of beta quantum systems 20B with the corresponding external quantum system, the corresponding switch 128 may be set to connect the entangled beta quantum system 20B to intra-node network 112 and switch 132 may be set to provide an optical connection between the entangled beta quantum system 20B and optical mixer 130.

In cases where it is desired to transfer the entanglement of the entangled beta quantum system 20B to a selected one of alpha quantum systems 20A of the node 102 then switch 134 may be set to provide an optical connection from the selected alpha quantum system 20A to optical mixer 130. The entanglement may then be transferred to the selected alpha quantum system 20A as described elsewhere herein.

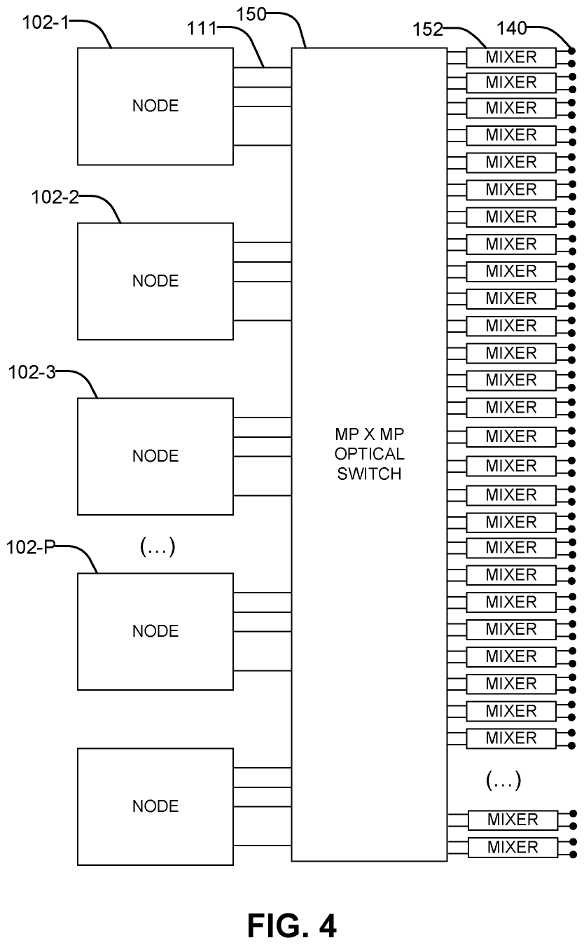

FIG. 4 is a block diagram that illustrates an example construction for inter-node network 110. In this example, P nodes 102-1 to 102-P each have M ports which each correspond to a beta quantum system 20B. These ports are respectively connected to corresponding ports of an MP×MP optical switch 150. Also connected to optical switch 150 are a plurality of optical mixers 152 each having two input ports and two output ports. Each of the output ports of each mixer 152 is connected to a corresponding single photon detector 140. Switch 150 may be operated to connect one beta quantum system 20B of one node 102 to a first input port of one of optical mixers 152 and to connect another beta quantum system 20B of a second one of nodes 102 to a second input port of the one of the optical mixers 152. Photons detected at the corresponding detectors 140 may herald entanglement of the beta quantum systems 20B of the first and second nodes that are optically coupled to mixer 152.

In some modes of operation, optical switch 150 may be configured to connect a plurality (e.g. from 2 to M) of the M ports of a first one of nodes 102 to first input ports of a corresponding plurality of mixers 152 and to connect the same number of the ports of a second one of nodes 102 to the second input ports of the corresponding plurality of mixers 152.

In some modes of operation, optical switch 150 may be configured to connect a first plurality (e.g. from 2 to M) of the M ports of a first one of nodes 102 to first input ports of a corresponding plurality of mixers 152 and to connect to each of the second input ports of the corresponding plurality of mixers 152 a port of one of a plurality of other nodes 102. Such modes may be used to simultaneously create entanglement of beta quantum systems 20B of the first one of nodes 102 with beta quantum systems of a plurality of other nodes 102.

Beta quantum systems 20B and alpha quantum systems 20A may, for example comprise matter qubits—as opposed to “flying” qubits (photons). In preferred embodiments, beta quantum systems 20B and alpha quantum systems 20A comprise luminescent centres in a substrate such as silicon. For example, alpha and beta quantum systems 20B and 20A may each be provided by a luminescent centre or an ensemble of luminescent centres in a substrate.

For example, the luminescent centre may comprise a luminescent centre selected from: a defect such as a T centre, an I centre, or an M centre, or a Nitrogen-Carbon centre, or an Al1 or a Ga1 centre, or a radiation damage centre with an unpaired ground state spin; or an impurity such as an atom of selenium or tellurium or sulphur or other double donor impurity.

In any embodiment, some or all of the quantum systems may be the same. For example, all of the alpha quantum systems, all of the beta quantum systems, all of the gamma quantum systems, all of the quantum systems in a cell or node, all of the quantum systems that can be connected by a particular optical link or network, or all of the quantum systems may have the same structures (e.g. be provided by the same type of luminescent centre).

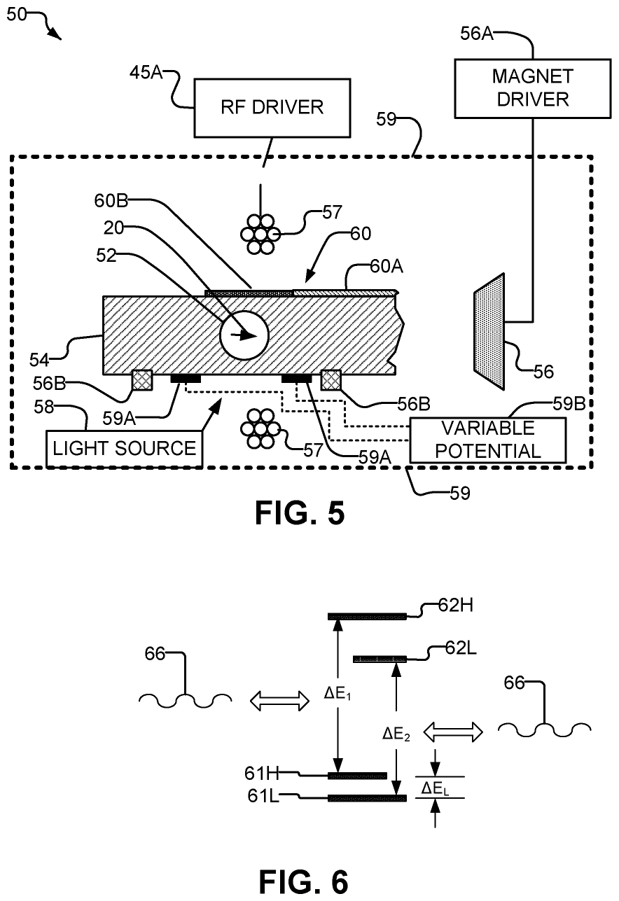

FIG. 5 schematically illustrates a structure 50 that provides an environment of an example quantum system 20 which may be an alpha quantum system 20A or a beta quantum system 20B. In some embodiments, quantum system 20 includes a luminescent centre 52 in a substrate 54. Substrate 54 may, for example comprise a silicon or diamond substrate.

Substrate 54 is preferably of a material made of atoms that do not have a net nuclear spin. For example, substrate 54 may comprise purified silicon 28 (i.e. silicon that is more than 92.23% silicon 28). In some embodiment the material of substrate 42 is at least 96% or 99% or 99.5% or 99.9% (by number of atoms) silicon 28.

FIG. 5 shows a magnet 56 that is operable to change a magnitude of a magnetic field at the location of quantum system 20 (and to therefore change a difference in energies between spin up and spin down states of a spin such as an electron spin or nuclear spin of quantum system 20). A control circuit 56A is connected to control adjustable magnet 56. One or more bias magnets 56B (which may be permanent magnets) in the vicinity of quantum system 20 may augment the magnetic field from adjustable magnet 56. Magnets 56B may, for example, be deposited on or in or near substrate 54.

FIG. 5 also shows an antenna 57 (e.g. comprising one or more coils) that may be driven by an RF signal source 57A to manipulate a quantum state of quantum system 20 by a resonance effect (e.g. electron spin resonance-“ESR”) as is known to those of skill in the art. RF signal source 57A may be controlled to produce pulses of radiation such as pi pulses or pi/2 pulses which, when delivered, manipulate the quantum state of quantum system 20. Antennas 57 may, for example be integrated into or deposited on a substrate in which the quantum system 20 is located or located sufficiently close to the quantum system 20 to deliver RF radiation to the quantum system 20 appropriate to manipulate the quantum state of the quantum system 20 in a desired way.

FIG. 5 also shows a narrow band light source 58 arranged to illuminate a location of quantum system 20. Light source 58 may, for example, emit light having a wavelength that corresponds to an optical transition of quantum system 20. The transition may, for example, comprise elevation of an electron from a ground state to an excited state, creation of an exciton, a spin flip transition etc. Light source 58 may, for example, comprise a laser. The laser may be tunable to emit light having wavelengths corresponding to different optical transitions of quantum system 20.

FIG. 5 also shows electrodes 59A and a variable potential circuit 59B configured to apply a controllable potential difference between electrodes 59A. Circuit 59B may be controlled to vary an electric field at the location of quantum system 20. The electric field may shift energy levels of quantum system 20 (e.g. by the Stark effect).

Structure 50 comprises an optical structure 60 that includes a waveguide 60A and a resonant cavity 60B. Cavity 60B augments optical coupling between quantum system 20 and waveguide 60A. Waveguide 60A may, for example optically couple quantum system 20 to intra-node network 112 and/or inter-node network 110.

Substrate 54 is contained within a refrigerator 59 capable of cooling substrate 54 to cryogenic temperatures. In some embodiments the operating temperature of structure 44 may be very low (e.g. a few mK or a few Kelvins).

Controllable elements of system 50 (e.g. magnet control circuit 56A, RF signal source 57A, light source 58, and/or variable potential circuit 59B) may be controlled by controller 118.

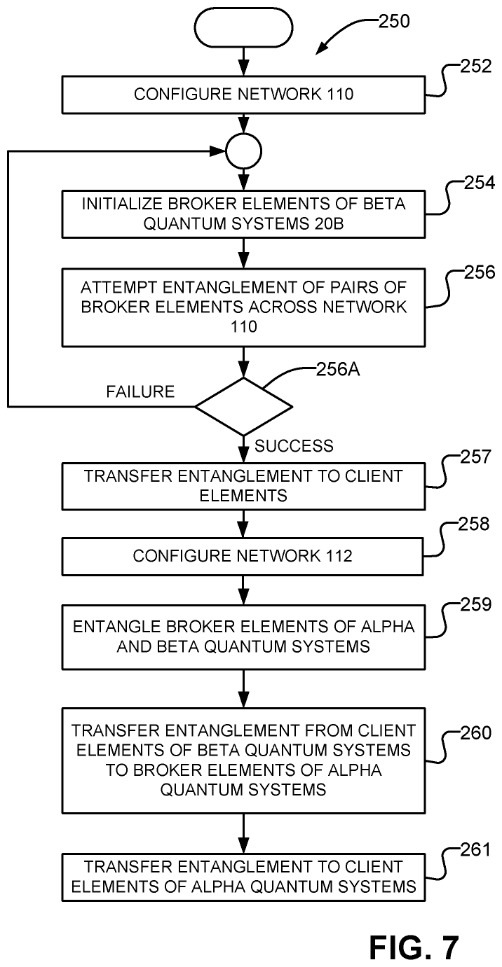

FIG. 6 is a non-limiting example energy level diagram for qubit 50. Ground state levels 61H and 61L may, for example, correspond to spin up and spin down states of an unpaired spin (e.g. an electron, nucleus or a hole). For example, levels 61H and 61L may be the result of hyperfine splitting caused by interactions between nuclear and electronic spins at the location of quantum system 20 or splitting caused by another magnetic field at the location of quantum system 20.

States 62H and 62L may, for example, correspond respectively to spin up and spin down states of an unpaired spin (e.g. of an electron, nuclear spin or a hole). States 62H and 62L may be related respectively to states 61H and 61L by an orbital or an excitonic transition. The energy differences between states 62H and 61H or between states 62L and 61L may correspond to the energy of photons at optical wavelengths.

As shown in FIG. 6 the energy difference ΔE1 between states 61H and 62H is different from the energy difference ΔE2 between states 61L and 62L. In some embodiments the difference between ΔE1 and ΔE2 corresponds to a frequency difference sufficient to provide spin-selective coupling of a spin of quantum system 20 to an optical structure 60 (e.g. by making resonator 60B to have a resonant frequency that corresponds to one of ΔE1 and ΔE2 where the Q factor for resonator 60B is high enough and the difference between ΔE1 and ΔE2 is large enough that photons having energies corresponding to the other one of ΔE1 and ΔE2 do not couple well to resonator 60B. For example, the difference between ΔE1 and ΔE2 may be at least about 1 MHz. (i.e. about 6.6×10⁻²⁸ J) or more typically at least about 100 MHz. In some embodiments the difference between ΔE1 and ΔE2 is at least 1 GHz (i.e. about 6.6×10⁻²⁵ J).

For example, when optical photons 66 which have a wavelength (or equivalently frequency or energy) corresponding to ΔE1 are provided, quantum system 20 may absorb one of the photons 66 and transition from state 61H to state 62H. Quantum system 20 may subsequently transition from state 61H to 62H and emit a photon 66 having the same energy ΔE1.

Since quantum system 20 is a quantum system, quantum system 20 is not necessarily in a definite quantum state. Instead, quantum system 20 may be in a superposition of different states (e.g. a superposition of states 61H and 61L). Also, states of quantum system 20 and optical photons 66 may together be in a superposition of states in which quantum system 20 has and has not emitted or otherwise interacted with a photon. In general, the quantum state of the quantum system made up of quantum system 20 together with optical photons 66 encompasses a wide variety of possible interactions between quantum system 20 and optical photons 66. Consequently, the quantum states of quantum system 20 and optical photons 66 can be entangled.

A more detailed example of a method according to the present technology will now be described. In this example, each of alpha quantum systems 20A and beta quantum systems 20B includes at least two elements. Each of the elements has a quantum state that can be independently controlled and quantum information may be selectively transferred among the elements of each quantum system 20. For example each of quantum systems 20 may include at least one electron spin and at least one nuclear spin which may each be applied to store quantum information.

In some embodiments, some or all of the quantum systems are provided by structures in which the broker element and one or more client elements have a fixed spatial relationship. For example a quantum system may be provided by a luminescent center that includes atoms having a set spatial arrangement in which an electron spin associated with one of the atoms may be applied as a broker element and nuclear spins associated with one or more of the atoms are applied as one or more client elements. In some embodiments, for some or all of the quantum systems hyperfine interactions between a broker element and a client element of the quantum system have the same strength. This can be the case, for example, where each of a group of the quantum systems comprises a substantially identical arrangement of atoms such that distances between the broker element and the client element are substantially identical.

The notation |↓ [symbol] indicates the combined quantum state of a quantum system that includes both an electron (or hole) spin represented by the first arrow and a nuclear spin represented by the second arrow. For the state |↓ [symbol] the electron or hole is spin down and the nuclear spin is spin up.

In some embodiments, one of the elements of a quantum system 20 is used as a broker and another element of the quantum system 20 may be used as a client. Broker elements may be used to exchange quantum information with other quantum systems 20. Client elements may be used to store quantum information in quantum systems 20. The client elements may have a longer decoherence time than the broker elements.

With this arrangement, quantum states of the broker elements (“broker quantum states”) of a pair of beta quantum systems 20B in different nodes 102 may be entangled as described above. Subsequently the entangled broker quantum states may be transferred to client elements of the beta quantum systems 20B. This frees the broker element of each beta quantum system 20B for use in transferring the entanglement to an alpha quantum system 20A.

Transferring the entanglement from a beta quantum system 20B to an alpha quantum system 20A may involve creating entanglement between broker elements of the beta quantum system 20B and the alpha quantum system 20A to which the entanglement is to be transferred.

FIG. 7 is a flow chart for an example method 250 which creates entanglement between broker elements of a pair of beta quantum systems 20B and then distributes that entanglement to client elements of selected alpha quantum systems 20A.

The resulting entanglement (e.g. an entangled Bell pair state) may subsequently be consumed for any purpose. This consumption may, for example, take the form of a remote quantum gate operating on client elements of one or more alpha quantum systems 22. Such a remote quantum gate may, for example be used to extend a pre-existing entangled state to a multipartite entangled state of three or more qubits.

In block 252 of method 250 network 110 is configured to pairwise optically connect each of a plurality of beta quantum systems 20B of node 102A to a corresponding one of a plurality of beta quantum systems 20B of node 102B in a way that facilitates entangling the beta quantum systems 20B of each pair.

In block 254 broker elements (e.g. electron spins) of beta quantum systems 20B of each of two nodes (e.g. nodes 102A and 102B-see FIG. 2A) are initialized to quantum states appropriate for a probabilistic entanglement protocol to be applied in attempts to entangle the quantum states of the broker elements of the pairs of quantum systems 102B.

In block 256, attempts are made to entangle the broker elements of each pair of beta quantum systems 20B. These attempts may be made in parallel for different pairs (e.g. at the same or overlapping times). Attempts to entangle the broker elements of different pairs of beta quantum systems 20B may be asynchronous or synchronous. Block 256 may apply any suitable entanglement protocol (e.g. a protocol that is probabilistic and/or heralded as described elsewhere herein).

Block 256 is repeated until it is verified that broker elements of at least one of the pairs of beta quantum systems 20B has been successfully entangled as determined at block 256A. In some embodiments, success at block 256A is detected by detecting a heralding pattern of photon detection events at optical detectors corresponding to one of the pairs of beta quantum systems 20B.

Block 257 transfers the entanglement established in block 256 to client elements (e.g. nuclear spins) of the entangled beta quantum systems 20B. After block 257, client qubit states of at least one pair of beta quantum systems 20B are entangled.

Block 258 configures network 112 to optically couple each of the entangled beta quantum systems 20B to a selected alpha quantum system 20A in the same node 102.

Block 259 uses the optical connection of block 258 to entangle quantum states of broker elements of the entangled beta quantum systems 20B with broker elements of the corresponding selected alpha quantum systems 20A.

A quantum entanglement protocol used to implement block 259 may operate probabilistically. However, since network 112 may be a low loss optical network successful entanglement may be heralded much more quickly than could be expected over lossier optical network 110. Block 259 may repeat entanglement attempts until successful entanglement is heralded.

Block 260 uses the entanglement created in block 259 to transfer the entanglement of the client elements of the entangled beta quantum systems 20B to the broker elements of the corresponding alpha quantum systems 20A (e.g. by quantum teleportation). After block 260, broker qubit states of at least one pair of alpha quantum systems 20A (where the alpha quantum systems 20A of the pair are in different nodes 102) are entangled.

Block 261 transfers the entanglement of the broker elements of the selected alpha quantum systems 20A to client elements of the selected alpha quantum systems 20A. After block 261, client qubit states of the selected alpha quantum systems 20A (where the selected alpha quantum systems 20A of the pair are in different nodes 102) are entangled. The resulting entanglement of client elements of alpha quantum systems 20A in different nodes 102 may then be consumed.

In some embodiments, alpha quantum systems 20A function as computational resources. For example, controller 118 may be configured to cause system 100 to execute quantum computing algorithms by initializing alpha quantum systems 20A to be in selected initial quantum states, manipulating quantum states of alpha quantum systems 20A, applying quantum gates to alpha quantum systems 20A, entangling alpha quantum systems 20A with one another and/or with alpha quantum systems 20A in other nodes 102 (e.g. as described above).

In method 250, electron spins may be used in the role of brokers (i.e. the broker elements may comprise electron spins) and nuclear spins may be used in the role of clients (i.e. the client elements may comprise nuclear spins.

For example, quantum systems 20 may each comprise a T-centre. Within a T-centre quantum information may be moved among an electron spin of the T-centre and one or more nuclear spins of the T-centre. In some embodiments the electron spin serves as a broker qubit and the nuclear spin serves as a client qubit.

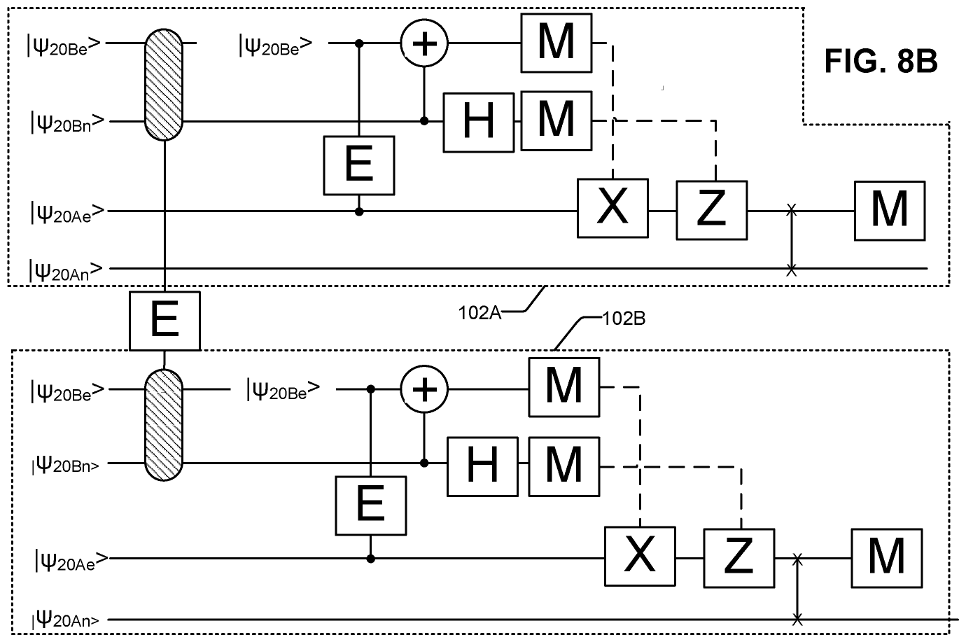

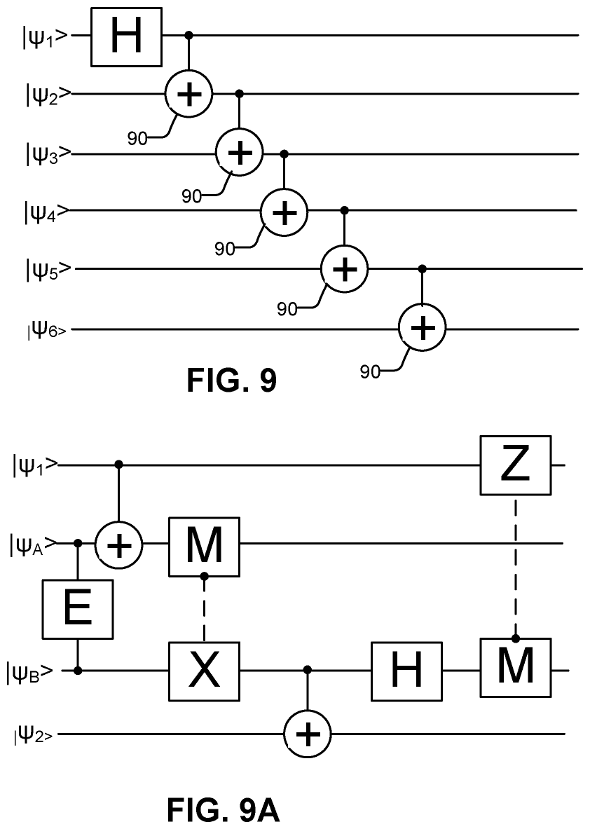

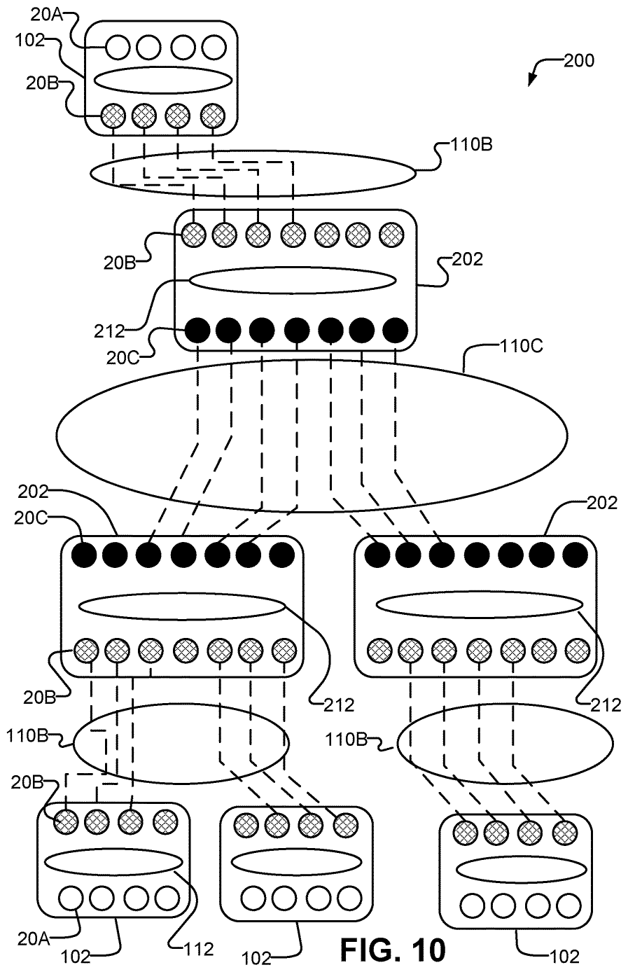

FIG. 8 shows a simple system 80 comprising two nodes 102-1 and 102-2. One beta quantum system 20B of each of nodes 102 is shown. One alpha quantum system 20A of each of nodes 102 is shown. Each beta quantum system 20B includes a broker element 81B and a client element 82B. Each alpha quantum system 20A includes a broker element 81A and a client element 82A.

In this example, broker elements 81A, 81B comprise electron spins (e) and client elements 82A, 82B comprise nuclear spins (n). For example, each of quantum systems 20A, 20B may comprise a T-centre. Client elements 82A, 82B may be provided by nuclear spins of the T-centre. Broker elements 81A, 81B may be provided by electron spins of the T-centre. The present technology is not limited to these choices of broker and client elements. Quantum systems 20 may take any of a wide variety of forms that include elements suitable for application as broker elements and client elements.

System 80 may include additional elements. For example, system 80 may include additional nodes, additional quantum systems, additional electron spins and/or additional nuclear spins (not shown). For example, each of nodes 102-1 and 102-2 of system 80 may each include several beta quantum systems 20B.

Suppose that it is desired to entangle the quantum state of a client element 82A of a selected alpha quantum system 20A of node 102-1 with the quantum state of a client element 82A of corresponding selected alpha quantum system 20A of node 102-2. An example way to achieve such entanglement includes several main steps which involve interactions 84-1 through 84-5. FIG. 8B is a diagram that indicates these interactions symbolically.

In FIG. 8B the quantum states are indicated by the symbol Y marked with a subscript that identifies specific elements of individual quantum systems 20. For beta quantum systems 20B the subscript includes “20B”. For alpha quantum systems 20A, the subscripts include “20A”. For broker elements the subscripts include “e”. For client elements the subscripts include “n”. In the quantum circuit diagrams of FIGS. 8B, 9 and 9A the symbol E represents an entanglement process, the symbol M represents measurement, the symbol H represents a Hadamard gate, the symbol X represents an X measurement, the symbol Z represents a Z measurement and the symbol + indicates a CNOT gate.

For the purposes of this example, quantum systems 20A, 20B have ground state energy levels as indicated in FIG. 8A. FIG. 8 is annotated to schematically illustrate interactions 84 (interactions 84-1 to 84-5 are shown) which parallel the blocks of method 250. Prior to interaction 84-1 beta quantum systems 20B are initialized. Initialization may, for example, comprise putting each of quantum systems 20B into the same ground state.

FIG. 8A illustrates the example where initialization comprises placing broker elements 81B of beta quantum systems 20B in the state 86C which corresponds to |g↑ [symbol] where g indicates ground state, ↑ indicates electron spin up and [symbol] indicates nuclear spin up.

This initialization may comprise, for example optically exciting each of beta quantum systems 20B with light having a wavelength corresponding to a transition 85-1 from either of states 86A and 86B to an excited state 75. Transition 85-1 may, for example, comprise an electron orbital transition.

The light may be delivered from a suitably tuned laser, for example. From excited state 75 the quantum state of broker element 81B may transition to state 86C (which may be a desired state for the initialization) or 86D (undesired state) by transition 85-2.

An RF drive may be applied to stimulate a transition 85-3 from state 86D back to state 86A or 86B. The RF drive may have a frequency corresponding the energy difference between state 86D and state 86A or 86B. Once quantum system 20B falls into state 86C it remains in state 86C because no transitions to other states are available.

The light and RF drive may, for example, be applied for a period sufficient to initialize beta quantum system 20B. The period required may be determined by simulations or experiments. Typically, it is sufficient to deliver the light and RF drive for a period of about 10 microseconds or less.

The broker element (electron spin) in each of quantum systems 20B may then be placed into a superposition of electron spin up and electron spin down (e.g. the state:

$$\vert ψ 〉 = \frac{\vert ↑ 〉 + \vert ↓ 〉}{\sqrt{2}} )$$

by applying a Sqrt(X) gate. The Sqrt(X) gate may, for example be applied by applying an RF pulse of around 10 ns (e.g. in the range of about 1 ns to about 1 μs) to cause a π/2 rotation around the x axis in the Bloch sphere representation of the quantum state of the electron spin. A suitable pulse duration may be determined by simulation or experimentally. The RF pulse may have a frequency that corresponds to the energy difference between states 86C and 86A.

Interaction 84-1 causes quantum states of broker elements 81B (electron spins) of beta quantum systems 20B to be entangled. In some embodiments multiple quantum systems 20B in each of nodes 102-1 and 102-2 are initialized and attempts are made to entangle quantum states of pairs of the broker elements of these quantum systems in parallel, as described above.

Entanglement may, for example, be achieved by applying to each of beta quantum systems 20B a pulse of light having a wavelength chosen to correspond to a spin-selective optical transition to an excited state (e.g. 75). “Spin selective” means that the transition occurs for only one electron spin state. If the transition occurs then a photon is emitted as the excited state decays. For example, the light may have a wavelength that corresponds to transition 85-1. The length of the pulse of light may be chosen so that only a single photon will be released. For example, the light pulse may have a duration on the order of 1 ns.

The skilled person will recognize that from excited state 75 there is a possibility of relaxation to one of states 86A or 86B as well as relaxation to one of states 86C or 86D. The likelihood each of these outcomes is determined by a “branching ratio”. Typically the branching ratio is such that the probability of relaxation back to one of states 86A or 86B is in the range of ~0% to about 10% while the probability of relaxation to one of states 86C and 86D is in the range of about 90% to ~100%.

During initialization of a quantum system 20 (as described above) transition 85-1 may be triggered many times so that relaxation happens many times. As a result, even if the probability of relaxing to state 86C or 86D is low, given enough cycles there is a high probability (approaching 100%) that the state of the quantum system 20 will be initialized into state 86C.

An entanglement protocol may, however, involve invoking transition 85-1 only once. There is therefore a finite probability that executing the entanglement protocol may cause a random change in the quantum state of quantum system 20 (e.g. by flipping the electron spin) with a probability (which may be small) determined by the branching ratio.

Since beta quantum systems 20B each were initialized to a quantum state involving a superposition of electron spin up and electron spin down the desired resulting combined state of the electron spin and any emitted photon is a superposition of a state in which the electron is spin up and one photon has been emitted and a state in which the electron is spin down and no photons have been emitted.

Any emitted photon states are routed by network 110 to an optical mixer (e.g. 152) that permits interference of photon states emitted by paired beta quantum systems 20B. The optical mixer may, for example, comprise free space optics and/or integrated optics. Delivery of optical pulses to quantum systems 20B is timed so that any emitted photon states will have the opportunity to interact with one another in the optical mixer. Single photon detectors at output ports of the optical mixer are monitored to detect cases for which exactly one photon is detected.

Next, a Ir RF pulse is delivered to each of beta quantum systems 20B. The π pulse rotates the quantum state of the electrons in quantum systems 71A and 71B by 180 degrees about the X axis in the Bloch sphere representation. The steps of applying a pulse of light having a wavelength chosen to correspond to the spin-selective optical transition and detecting any emitted photons are then repeated.

A single detected photon after each light pulse heralds entanglement of the quantum states of the electrons of paired beta quantum systems 20B. If photons are detected in any other combinations (e.g. zero photons or two photons at either stage), the entanglement process is restarted.

In interaction 84-2 the entanglement is transferred to client elements 82B (nuclear spins) of beta quantum systems 20B. Interaction 84-2 may, for example be caused to transfer entanglement of the electron spins in paired beta quantum systems 20B to nuclear spins of quantum systems 20B by applying a SWAP gate between the electron and nuclear spins. Applying the SWAP gate may, for example, comprise applying an RF pulse tuned to a frequency that corresponds to an energy difference between states 86A and 86D for a time sufficient to promote transition from the state |g↑ [symbol] to the state |g↓ [symbol] and vice versa. The pulse length for the SWAP gate may be determined from simulation and/or experiment and may, for example, be on the order of 100 ns (e.g. in the range of 10 ns to 1 μs). To implement the SWAP gate in this manner it must be possible to induce the cross-transition between states 86A and 86D. Some quantum systems including T-centres are characterized by hyperfine tensor anisotropy which facilitates driving this cross-transition.

An advantage to transferring the entanglement to nuclear spins of quantum systems 71 can be that the nuclear spins are typically better isolated from the environment than electron spins and consequently the decoherence time of the nuclear spins may be significantly longer than the decoherence time of the electron spins. Also, transferring the entanglement to the nuclear spins of beta quantum systems 20B frees the electron spins of quantum systems 20B for the next step.

In interactions 84-3 and 84-4 the entanglement is transferred to broker elements (e.g. electron spins) 81A of alpha quantum systems 20A in each of nodes 102-1 and 102-2. In interaction 84-3 the quantum state of the electron spin of a beta quantum system 20B is entangled with that of the electron spin of the selected alpha quantum system 20A. These entanglements may be brought about by the identical steps described above for entangling the quantum state of the electron spins of beta quantum systems 20B except that the collection and detection of photons is performed on intra-node optical network 112 in each case, and the initialization procedure described above is modified so that only the broker elements (electron spins) of a beta quantum system 20B and the corresponding selected alpha quantum system 20A are initialized. In this modified initialization procedure, quantum systems 20B may be excited with light at a wavelength equal to a transition 85-1 from either of states 86A and 86B to an excited state 75. A nonzero probability of relaxing via transition 85-2 into states 86C and 86D then shelves the broker spin in the state |1> as transition 85-2 is cycled. This procedure therefore initializes the broker element 82B into a known state while minimally perturbing the quantum state of the corresponding client element (e.g. nuclear spin) 82B. Typically, it is sufficient to deliver the light for a period of about 1 microsecond or less.

In interaction 84-4 the quantum state of client elements 82B (e.g. nuclear spins) of beta quantum systems 20B are teleported to broker elements 81A (e.g. electron spin) of the corresponding selected alpha quantum systems 20A in each of nodes 102-1 and 102-2. This may be done independently in nodes 102-1 and 102-2.

The teleportation consumes the entanglement of the broker elements 81A, 81B of the alpha and beta quantum systems 20A, 20B.

The teleportation in each node may, for example, comprise performing a local Bell state measurement on the electron spin and nuclear spin of beta quantum system 20B.

The Bell state measurement may, for example be performed by the following sequence of acts:
1. apply a CNOT gate to the electron spin of beta quantum system 20B using as the control the nuclear spin of beta quantum system 20B.
2. perform a Z measurement on the electron spin of beta quantum system 20B.
3. if the Z measurement results in an even parity state: apply a TT rotation to the electron spin of the corresponding alpha quantum system 20A.
4. perform an X measurement on the nuclear spin of beta quantum system 20B (i.e. a projective measurement into the X basis).
5. apply feed forward to the electron spin of beta quantum system 20B.

If the nuclear spin is up, the CNOT gate flips the electron spin. Otherwise the CNOT gate takes no action. It can be seen from FIG. 8A that the CNOT gate represents a transition from state 86C to state 86A. The CNOT gate may, for example be implemented by applying an RF pulse having a frequency selected to correspond to the energy difference between states 86A and 86C for a duration chosen to swap states 86A and 86C. This duration may be determined through simulation and/or experimental calibration. The duration may, for example be on the order of 10 μs (e.g. a period in the range of 100 ns-100 μs).

Performing a Z measurement on the electron spin of beta quantum system 20B may comprise using resonant, spin-selective optical cycling and photon detection. If a photon is detected then the result of the measurement is that the electron spin has a state corresponding to the spin-selective transition. This measurement may comprise applying light having a wavelength resonant with the spin-selective transition for sufficient time to generate and detect a photon. Preferably the measurement generates and detects multiple photons for better measurement fidelity. For example, the measurement may involve applying the light for a time sufficient to generate and detect enough photons to verify the spin stated with at least a threshold fidelity (e.g. 90% fidelity or greater). In some example embodiments the light is applied for a period of approximately 10 ns (e.g. in the range of 1 ns to 50 ns). The duration of the pulse may be determined based on simulation and/or experiment.

Performing the X measurement of client element 81B (e.g. nuclear spin) may comprise, for example, applying a π/2 pulse on the nuclear transition to rotate the X Bloch sphere projection onto the Z axis and then using resonant spin-selective optical cycling of the broker spin, while applying an RF drive with frequency equal to the separation between states 86C and 86A to measure the spin-up population of the nuclear spin of beta quantum system 20B. The π/2 pulse may, for example have a duration of approximately 10 μs (e.g. in the range of 1-100 μs). The resonant spin-selective optical cycling may, for example have a duration of approximately 10 μs (e.g. in the range of 5-50 μs).

Feed forward may comprise: If the X measurement of the client element 82B e.g. (nuclear spin) of beta quantum system 20B revealed even parity (e.g. the |−> state—i.e. the state | [symbol] >−| [symbol] >) then apply a [z] gate to the electron spin of beta quantum system for a pi rotation about the Z axis of the Bloch sphere. Otherwise, if the X measurement revealed odd parity (e.g. the |+> state—i.e. the state | [symbol] >+| [symbol] >) then do nothing. Applying the [z] gate may, for example comprise altering energy of the broker element 81B (e.g. electron spin) of the beta quantum system 20B e.g. by applying an electric field or changing a magnetic field for a period of time sufficient to allow the state to accumulate a phase shift of π radians or by advancing the phase of the state in phase tracking software.

In interaction 84-5 the entanglement is transferred to client elements (nuclear spins) 82A of alpha quantum systems 20A. After the quantum state of the nuclear spin of beta quantum system 20B has been transferred to the electron spin of alpha quantum system 20A (e.g. as described above) the entanglement may be transferred to a nuclear spin of alpha quantum system 20A as indicated by interaction 84-5. This may be performed in the same manner described above in relation to interaction 84-2.

The method described above is not limited to the case where alpha and beta quantum systems 20A and 20B include electron spins and nuclear spins. The method may be applied more generally to the case where nodes 102A and 102B have available alpha and beta quantum systems that can serve to transfer quantum information as described. Also, those of skill in the art will recognize that the described methods may be varied by using other combinations of quantum gates and manipulations that yield equivalent results.

### Creating Multipartite Entangled States

FIG. 9 illustrates a method for creating a multipartite entangled state involving three or more qubits which may be located in different nodes. The horizontal lines in FIG. 9 represent individual qubits which initially have quantum states |ψᵢ> where iε{1, . . . , 6}. In FIG. 9, H indicates a Hadamard gate. CNOT gates 90 are sequentially applied to add additional qubits to the entangled state. Each CNOT gate 90 is controlled by the top qubit to which the gate is connected.

Because the individual qubits may be in different nodes the CNOT gates may be implemented as teleported nonlocal CNOT gates as described for example in J. Eisen, Phys. Rev. A 62, 052317 2000. Teleporting the gates between two nodes may apply a pair of entangled qubits that may, for example be entangled using the techniques described above as a resource.

FIG. 9A schematically illustrates implementation of a teleported CNOT gate between quantum states |ψ₁> and |ψ₂> using entangled states |ψ_{A}> and |ψ_{B}>.

### Segmented Architecture—Example Features and Variations

It can be appreciated that segmenting a distributed quantum network (e.g. a quantum computer) into a nested network having plural layers (e.g. alpha and beta layers or alpha, beta and gamma layers etc.) may advantageously provide an increased rate of achieving entanglement between higher level (e.g. “beta” and/or “gamma”) quantum states by executing attempts to entangle multiple pairs of the higher level quantum states concurrently.

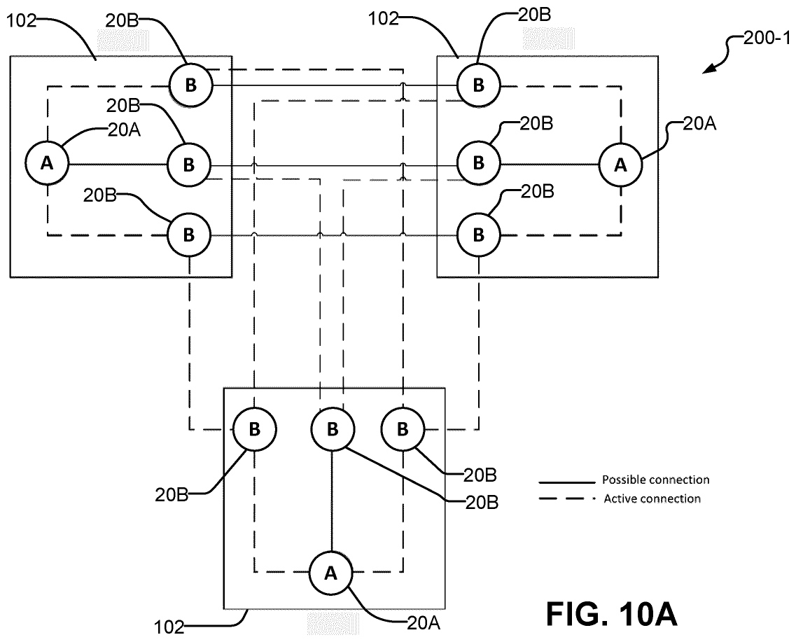

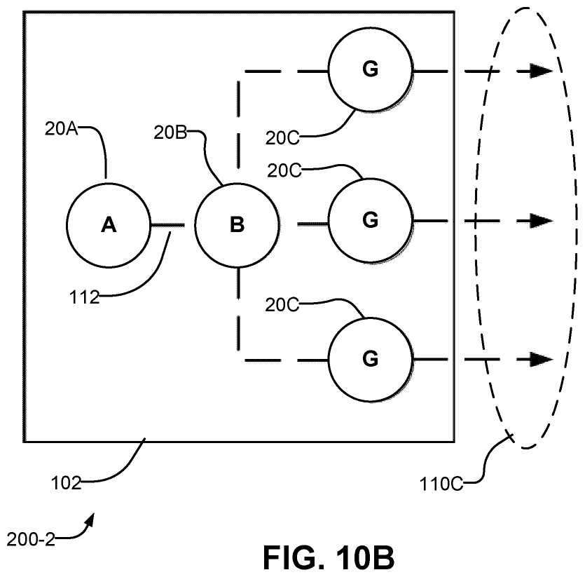

FIG. 10 shows an example quantum network 200 having three layers of quantum systems (alpha quantum systems 20A, beta quantum systems 20B and gamma quantum systems 20C). In this example, inter-node optical network 110 comprises an optical network 110C which may be applied to establish entanglement among gamma quantum systems 20C and optical networks 110B which may be applied to establish entanglement among quantum systems 20B.

Network 110 also includes nodes 202 which include both gamma quantum systems 20C and beta quantum systems 20B together with optical networks 212 that may be applied to extend entanglement from a quantum system 20C to a quantum system 20B (e.g. in a manner similar to intra-node network 112 of nodes 102). Optical networks 212 may, for example, be low loss optical networks similar to networks 112.

In some embodiments optical network 110C is significantly lossier than optical networks 110B or 112. In some embodiments the time required to establish entanglement of pairs of gamma quantum systems 20C is reduced by concurrently attempting entanglement of a relatively larger number of pairs of quantum systems 20C as compared to the number of pairs of beta quantum systems 20B for which entanglement attempts are concurrently attempted using an optical network 110B.

In a network that has three of more layers (e.g. alpha, beta and gamma layers), each layer may have different functionality. Quantum systems of the lowest level (e.g. alpha) layer may be used to store and manipulate quantum information (e.g. to perform quantum computations). Quantum systems of one or more highest layers (e.g. gamma quantum systems) may be used to establish entanglement between different cells. Quantum systems of an intermediate layer (e.g. beta) may serve both to isolate the lowest layer quantum systems from the highest layer quantum systems and to distill and/or purify entanglement generated among the highest layer quantum systems.

For example, entanglement may be established between multiple pairs of quantum systems at an “entanglement layer” (e.g. gamma layer). The entanglement may be transferred to a “distillation/purification layer (e.g. beta layer) where plural pairs of entangled quantum systems are transformed to obtain a smaller number of maximally entangled pairs. The purification or distillation may be performed using any suitable purification/distillation procedure. The maximally entangled pairs of beta quantum systems may then be consumed to perform processing at the lowest “computational” layer (e.g. by teleporting quantum states and/or quantum gates between cells.

FIGS. 10A to 10C are additional non-limiting examples of possible topologies of systems as described herein. FIG. 10A schematically shows a system 200-1 in which nodes or cells 102 each include an alpha quantum system 20A and a plurality of beta quantum systems 20B. An intra-node network 110 is configurable to provide an optical link that associates a beta quantum system of one of nodes 102 with one of a plurality of corresponding beta quantum systems in two or more other nodes 102. This architecture facilitates establishing entanglement among beta quantum systems 20B of any pair of nodes 102 of system 200-1.

FIG. 10B schematically shows an example node 102 of a system 200-2. System 200-2 may have any number of nodes 102. Node 102 includes a quantum system 20A and a corresponding beta quantum system 20B interconnected by an optical network 112. In this example, beta quantum system 20B serves as an intermediary between alpha quantum system 20A and a plurality of gamma quantum systems 20C. This configuration may provide improved isolation of quantum states of alpha quantum system 20A from noise caused by operation of gamma quantum systems 20C (e.g. in order to execute entanglement protocols involving gamma quantum systems 20C).

FIG. 10C schematically shows an example node 102 of a system 200-3. The node of FIG. 10C is similar to the node of FIG. 10B except that the node includes plural beta quantum systems 20B, each associated with a corresponding alpha quantum system 20A and an optical network of the node allows each of beta quantum systems 20B to be selectively connected to any of a plurality of gamma quantum systems 20C. The node of FIG. 10C may be scaled to include any number of pairs of corresponding alpha/beta quantum systems in which each of the beta quantum systems is selectively connectible to any of two, three or more gamma quantum systems 20C by optical network 110B.

In a system in which network 112 connects each alpha quantum system 20A to one corresponding beta quantum system 20B as illustrated in FIGS. 10B and 10C (and not to any other alpha or beta quantum systems) network 112 has low connectivity and may provide relatively very low probability of loss of photons.

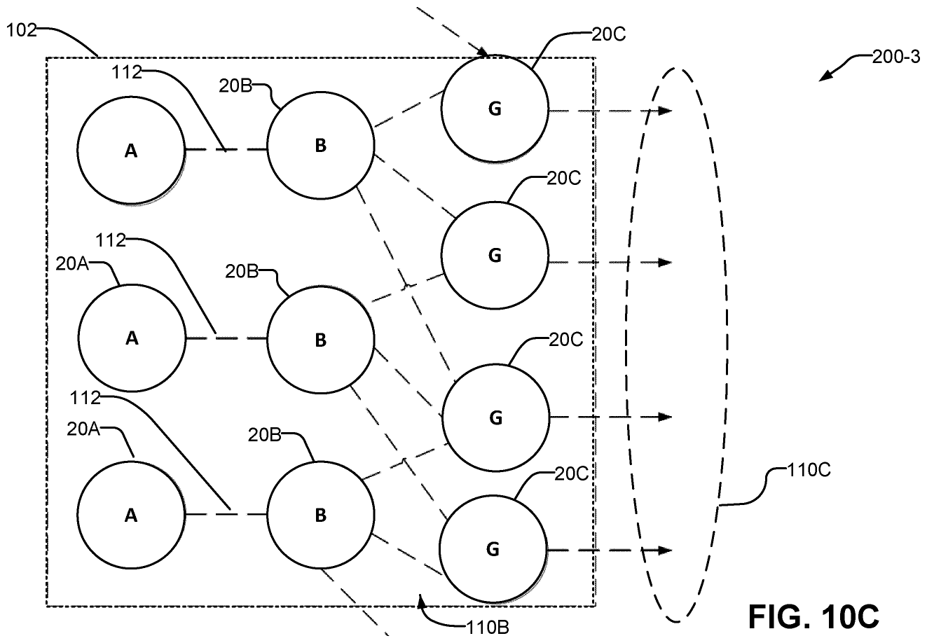

The rate of entanglement between the two beta-beta qubit banks or two gamma-gamma qubit banks increases as (1−(1−p)\hat{ }N) where p is the probability of a single channel succeeding in any given attempt and N is the number of beta-beta channels attempting entanglement in parallel. FIG. 11 is an example plot of this function for the case where the probability of achieving entanglement in any attempt is 10%. This increase in entanglement rate can result in faster operation speed for distributed quantum information processing.

In some embodiments entanglement of beta quantum systems may be generated continuously or periodically or otherwise speculatively. This can be particularly practical where beta quantum systems that are entangled have long coherence times (e.g. coherence times of 100 microseconds or more). In such cases pairs of entangled beta quantum systems may be instantaneously available as a resource which may be used, for example to teleport quantum states among nodes, teleport gates among nodes, extend entanglement to existing nodes, etc.

A nested network can also be designed to provide a layer of protection against noise and interference between beta and alpha quantum systems. Computational qubits (e.g. represented by quantum states of alpha quantum systems) may be isolated from the noise that accompanies probabilistic entangling gates (as may be used to create entanglement of remote quantum systems) especially where the probabilistic gates are applied across a highly connected map. This problem still exists even where quantum systems are used that incorporate broker qubits and client qubits and the broker qubits of different quantum systems are entangled using probabilistic entangling gates. Even with this arrangement the client qubits will inevitably be perturbed by probabilistic entanglement attempts involving the corresponding broker qubit due to coupling between the broker qubit and the client qubit. These perturbations add constructively with each attempt of a probabilistic entanglement protocol so the integrated magnitude of the perturbation increases with lossiness of the link used in attempts to entangle the broker qubits.

Links tend to grow lossier as connectivity grows. The quantum state of a client qubit that is regularly exposed to these perturbations would be rapidly corrupted. This makes such client qubits not ideal for use as computational qubits. With a nested architecture as described herein where alpha quantum systems can host computational qubits those computational qubits are isolated from perturbations associated with a large number of entanglement attempts over the relatively lossy inter node network (e.g. network 110).

An alpha quantum system may instead be exposed to the relatively low-loss photonic links of an intra-node network (e.g. network 112). This reduces the number of entanglement attempt cycles that alpha quantum systems undergo. The beta quantum systems are not necessarily used for computation. Consequently, quantum states of the beta quantum systems (brokers and clients) can be freely reset whenever they have become corrupted. Moreover, beta quantum system clients do not need to contain computational information and can exist in eigenstates that are thus less susceptible to the perturbations associated with entanglement attempts.

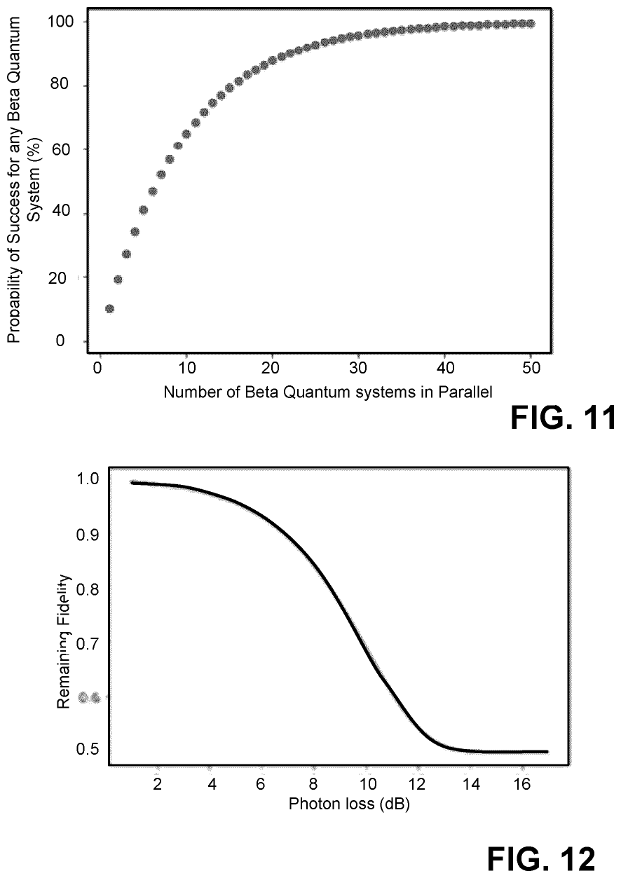

FIG. 12 is a plot that indicates the effect of this insulation. The curve in FIG. 11 is based on a simulation of the remaining fidelity of an entangled two client qubit state as a function of photon loss after the network has gone through the necessary stages of probabilistic entanglement to add an additional quantum system to the entangled state. Since high connectivity typically means high photon loss, operating with low loss in the alpha network (e.g. 112) and allowing high photon loss on the beta network (e.g. 110) generates a highly-connected and effectively low-loss entanglement network.

### Example Applications

The foregoing description illustrates principles and building blocks that enable a wide range of systems to be constructed. Some such systems may have fixed configurations. Some such systems may have dynamically variable configurations.

Systems as described herein may be made to be operable in a range of alternative operation modes (which may be determined, for example, by the configuration of controller 118). For instance:
Beta-beta entanglement attempts between plural beta quantum systems of one node and plural beta quantum systems of another node may be performed in parallel.
Beta-beta entanglement attempts between beta quantum systems of one node and two or more other nodes may be performed in parallel (it is not mandatory that the parallel entanglement attempts occur between the same two nodes).
A number of quantum systems configured for use as beta quantum systems in a particular node or nodes may be varied. For example individual quantum systems in a node may be used as alpha quantum systems and then reconfigured for use as beta quantum systems or vice versa.
A system may be operated to maintain an entanglement resource in which a supply of desired numbers of entangled quantum systems is created and kept available. For example the system may be configured to create entangled groups of two or more quantum systems where each group includes quantum systems belonging to two or more nodes. The number and configuration of entangled quantum systems provided to different nodes may be varied to suit demand. This entanglement may be exploited for example to teleport gates or quantum states between nodes, create entanglement of alpha quantum states in different nodes etc. The system may be configured to keep the entanglement resource available (e.g. by automatically creating a replacement group of entangled quantum systems before entanglement of an existing group of entangled quantum systems is expected to be lost as a result of decoherence or other effects),
A system may be expanded or connected to other systems like those described herein by establishing entanglement among higher level quantum systems (e.g. gamma optical systems) that are interconnected by additional optical links).
A system may vary its operation based on performance of optical links. For example performance of inter-node network 110 (e.g. lossiness) may vary with time. A system may be configured to monitor performance of one or more optical links and vary its operation in response to the performance, for example by attempting entanglement of more pairs of beta quantum systems in parallel, and/or keeping available a larger resource of entangled beta quantum systems and/or using a different entanglement protocol when performance of the optical link is worse.

As described herein, a difference between “alpha” and “beta” quantum systems is their connectivity. Alpha quantum systems are connected to a relatively low-loss inter-node network 112 while beta quantum systems are selectively connectible to either an inter-node network 110 (which may be lossy relative to inter-node networks 112) and the intra-node network 112.

In some embodiments all quantum systems that host qubits (or a number of quantum systems that host qubits that is larger than a number of the quantum systems that are usually used at once as beta quantum systems) are selectively connectible to either the inter-node network 110 or the intra-node network 112 (e.g. by a switch 128). In such embodiments, any of the selectively connectible quantum systems may be used as beta quantum systems (e.g. by exercising control to selectively connect the quantum system to inter-node network 110 at some times and to connect the quantum system to intra-node network 112 at other times) or as alpha quantum systems (e.g. by connecting the quantum system only to intra-node network 112 at all times or at selected times). In such embodiments a particular quantum system may be used as an alpha quantum system at some times and as a beta quantum system at other times.

In some embodiments one or more qubits of one or more beta quantum systems is temporarily configured as an alpha quantum system (e.g. by disconnecting from inter-node network 110). For example, such qubit(s) may be applied as ancilla qubit(s) for quantum computations being performed using qubits of alpha quantum systems.

In some embodiments, two or more different entangling protocols are applied at different times and/or between different pairs of quantum systems. For instance, entanglement between pairs of beta quantum systems may be made using a protocol that generates high fidelity entanglement at the expense of entanglement bandwidth (e.g. beta-beta connections may be performed using a two-photon Barrett-Kok entangling scheme). In the same system entanglement between a pair of an alpha quantum system and a beta quantum system (“alpha-beta entanglement”) may be performed with a single-photon heralding protocol (such a protocol may sacrifice fidelity for very high entanglement bandwidth, thereby minimizing the number of entanglement attempts to achieve entanglement). In some embodiments, other entanglement protocols are used for establishing entanglement by way of particularly lossy connections (e.g. connections of inter-node network that extend between cryostats or extend over long distances or connections of a ‘gamma’ network layer that connects plural beta networks to form a larger system).

The technology may be varied. For example, it is not mandatory for entanglement of beta quantum systems 21 to be created on demand. In some embodiments controller 118 operates to continuously attempt to create entanglement between beta quantum systems 21 of different nodes 102. In this mode of operation entangled pairs of beta quantum systems may be more or less continuously available as a resource.

Systems as described herein have a wide range of applications, for example, distributing cryptography keys; distributed quantum computing, transmission of quantum information. storage and retrieval of quantum information, etc.

### Example Implementation of Controllers

Control systems for implementing the technology described herein (e.g. controller 118) may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein (e.g, methods for establishing entanglement of qubits in different nodes) by executing software instructions in a program memory accessible to the processors.

The present technology may also be implemented in the form of a program product that contains software instructions which, when executed, cause a data processor to perform a method as described herein. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

### Interpretation

Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, as well as all other numerical values that are near to or approximately equal to that numerical value. A particular numerical value is included in “about” a specifically recited numerical value where the particular numerical value provides the substantial equivalent of the specifically recited numerical value in the context in which the specifically recited numerical value is presented.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1.-77. (canceled)

78. A method for establishing and distributing quantum entanglement, the method comprising:
providing first and second nodes, each node comprising one or more first quantum systems, a plurality of second quantum systems, and an intra-node optical network, the first and second quantum systems of each node interconnected via the intra-node optical network of the node and the second quantum systems of the first node connectable to at least corresponding second quantum systems of the second node via an inter-node optical network, wherein a network connectivity associated with the inter-node optical network is greater than that associated with the intra-node optical networks;
attempting to establish, via the inter-node optical network, quantum entanglement of quantum states of one or more pairs of second quantum systems, wherein each pair of second quantum systems comprises one of the second quantum systems of the first node and one of the second quantum systems of the second node;
detecting success in entangling the quantum states of one of the pairs of second quantum systems to provide an entangled pair;
transferring, via the intra-node optical network of the first node, entanglement of the entangled pair to a selected one of the first quantum systems of the first node.

79. The method according to claim 78 wherein the one or more pairs of second quantum systems comprises two or more pairs of the second quantum systems and attempting to establish quantum entanglement of quantum states of the two or more pairs of second quantum systems is performed concurrently.

80. The method according to claim 78 wherein the first and second quantum systems each comprises a broker element having a broker state and a client element having a client state and the method comprises:
entangling the broker states of the one or more pairs of second quantum systems;
transferring the entanglement to the client states of the second quantum systems of the one or more pairs of second quantum systems; and
transferring the entanglement to the client state of the selected one of the first quantum systems of the first node.

81. The method according to claim 80 wherein the broker state and the client state respectively comprise first and second spin states.

82. The method according to claim 81 wherein the first spin state comprises an electron spin state.

83. The method according to claim 81 wherein the second spin state comprises a nuclear spin state.

84. The method according to claim 78 wherein the first and second quantum systems are embedded in a crystalline substrate.

85. The method according to claim 78 wherein the quantum systems comprise luminescent centres.

86. The method according to claim 85 wherein the quantum systems comprise T centres.

87. The method according to claim 78 comprising distilling the entanglement of a plurality of entangled pairs of the second quantum systems to obtain a corresponding distilled entanglement and transferring, via the intra-node optical network of the second node, the corresponding distilled entanglement to a selected one of the one or more first quantum systems of the second node.

88. A quantum network comprising:
a plurality of nodes, each of the nodes comprising:
at least one first quantum system, a plurality of second quantum systems; and an intra-node optical network optically coupled to the at least one first quantum system and the plurality of second quantum systems;
an inter-node optical network configurable to provide a plurality of optical paths, each of the optical paths optically connecting a corresponding pair of the second quantum systems, each of the pairs of second quantum systems including one of the second quantum systems of a first one of the nodes and a corresponding one of the second quantum systems of a second one of the nodes, wherein a network connectivity associated with the inter-node optical network is greater than that of the intra-node optical networks; and
a controller configured to:
concurrently execute, via the inter-node optical network, attempts to entangle the second quantum systems of each of the pairs of second quantum systems;
upon detecting entanglement of the second quantum systems of an entangled one of the pairs of second quantum systems, transfer, via the intra-node optical network of the first one of the nodes, an entangled state of the entangled one of the pairs of second quantum systems to a selected one of the one or more first quantum systems of the first one of the nodes and/or transfer, via the intra-node optical network of the second one of the nodes, the entangled state of the entangled one of the pairs of second quantum systems to a selected one of the one or more first quantum systems of the second one of the nodes.

89. The quantum network according to claim 88 wherein the first and second quantum systems each comprises a broker element having a broker state and at least one client element having a client state.

90. The quantum network according to claim 89 wherein the controller is further configured to:
execute a protocol for entangling the broker states of the pairs of second quantum systems;
upon entanglement of the broker states of the entangled one of the pairs of second quantum systems, execute a protocol for transferring the entanglement to the client states of the second quantum systems of the entangled one of the pairs of second quantum systems;
execute a protocol for entangling the broker state of the second quantum system of the entangled one of the pairs of second quantum systems of the first one of the nodes with the broker state of the selected one of the first quantum systems of the first one of the nodes;
execute a protocol for transferring the entanglement of the client state of the second quantum system of the entangled one of the pairs of second quantum systems of the first node to the client state of the selected one of the first quantum systems of the first one of the nodes.

91. The quantum network according to claim 89 wherein the broker state and the client state respectively comprise first and second spin states.

92. The quantum network according to claim 91 wherein the first spin state comprises an electron spin state.

93. The quantum network according to claim 91 wherein the second spin state comprises a nuclear spin state.

94. The quantum network according to claim 89 wherein a strength of hyperfine coupling between the broker element and the client element is the same for each of the first quantum systems.

95. The quantum network according to claim 88 wherein each of the first quantum systems and/or each of the second quantum systems is embedded in a crystalline substrate.

96. The quantum network according to claim 88 wherein the quantum systems comprise luminescent centres.

97. The quantum network according to claim 96 wherein the quantum systems comprise T centres.
